(19) United States
(12) Patent Application Publication
(10) Pub. No.: US 2026/0215378 A1
(43) Pub. Date: Jul. 30, 2026

(54) ADAPTER FOR HANDHELD TOOL

(71) Applicant: Zebulun Robert Leffler, Varysburg, NY (US)

(72) Inventor: Zebulun Robert Leffler, Varysburg, NY (US)

(21) Appl. No.: 19/575,029

(22) Filed: Mar. 23, 2026

Related U.S. Application Data
(63) Continuation-in-part of application No. 18/237,943, filed on Aug. 25, 2023, now Pat. No. 12,600,017.

(51) Int. Cl. A01G 23/10; B23B 45/00

(52) U.S. Cl. CPC A01G 23/10; B23B 45/003

(57) ABSTRACT

An adapter for securing a second object to a first object includes a curved band defining an opening and having an inner surface and an outer surface. A step-down portion extends circumferentially about the outer surface of the curved band and is configured to receive the second object. A plurality of grooves are disposed on the inner surface of the curved band and extend from a front circumferential side to a rear circumferential side. The curved band is configured to fit over a generally cylindrical portion of the first object to secure the adapter thereto. In some embodiments, one or more grooves receive ribs on the first object to resist relative rotation, and one or more lips or tabs resist axial displacement. The adapter may be used with a tree-tapping tool assembly mounted to a handheld drill, wherein the adapter is interposed between the drill and an adjustable ring.

### PRIORITY CLAIM AND RELATED APPLICATIONS

This continuation-in-part application claims the benefit of priority from non-provisional application U.S. Ser. No. 18/237,943 filed on Aug. 25, 2023. Said application is incorporated by reference in its entirety.

### BACKGROUND OF THE INVENTION

### 1. The Field of the Invention

The present invention relates to tools used in connection with tapping trees for sap collection. More particularly, the present invention relates to a tree-tapping tool configured to be mounted to a handheld drill and to an adapter configured to improve securement of the tree-tapping tool to the drill.

### 2. Background Art

The tapping of a maple tree for sap collection involves drilling an elongated hole in the tree trunk so that a spout may be installed to facilitate collection of sap. To maintain proper sap yield, it is important that the elongated hole be formed with consistent diameter and depth. Variations in hole geometry can result in improper spout seating and air leakage, which may negatively affect sap production.

To improve consistency in drilling, tree-tapping tools have been developed that are configured to be mounted to a handheld drill. Such tools may include a stabilizing structure, such as a front plate with surface-engaging members, that contacts the tree surface before the drill bit advances. By stabilizing the drill relative to the tree, these tools assist in guiding the drill bit and promoting repeatable hole geometry.

In certain embodiments, a tree-tapping tool includes an adjustable ring configured to be secured to a generally cylindrical portion of a drill, such as a clutch adjustment ring or adjacent housing. When properly secured, the adjustable ring provides a stable mounting interface between the drill and the remainder of the tree-tapping tool.

Handheld drills, however, are produced in a variety of configurations. The outer diameters, rib patterns, axial lengths, and surface contours of clutch adjustment rings and adjacent cylindrical portions may differ among manufacturers and models. While direct securement of an adjustable ring to a drill may provide satisfactory performance in many instances, variations in drill geometry can influence the conformity between the adjustable ring and the drill surface. In some circumstances, differences in rib configuration or surface contour may affect resistance to relative rotation or axial movement during use.

Accordingly, there exists a need for an adapter configured to be mounted over a generally cylindrical portion of a handheld drill and to provide a defined outer mounting interface for receiving the adjustable ring of a tree-tapping tool. Such an adapter may enhance securement between the drill and the tool, improve conformity across different drill geometries, and increase resistance to relative movement during operation. In certain embodiments, the adapter may include features configured to accommodate surface ribs, permit controlled radial flexure for improved fit, and resist axial displacement once installed.

By interposing an adapter between the drill and the adjustable ring, the tree-tapping tool may be secured to a broader range of drill models in a stable and predictable manner while preserving the effective operation of previously developed tapping tool designs.

### SUMMARY OF THE INVENTION

In accordance with the present invention, there is provided an adapter including:
(a) a curved band defining an opening and having an inner surface, an outer surface, a front circumferential side, and a rear circumferential side, the inner surface being disposed opposite the outer surface;
(b) a step-down portion disposed on and extending circumferentially about a radially outer surface of the curved band, the step-down portion having an outer diameter smaller than an outer diameter of an adjacent portion of the curved band; and
(c) a plurality of grooves disposed on the inner surface of the curved band, each groove extending in a direction from the front circumferential side to the rear circumferential side,
wherein the curved band is configured to be fitted over a generally cylindrical portion of a first object to secure the adapter to the first object, and
wherein the step-down portion is configured to receive a second object fitted over the step-down portion to secure the second object to the first object.

In one embodiment, the generally cylindrical portion of the first object includes at least one radially protruding rib, and wherein at least one of the plurality of grooves is configured to receive the at least one rib to resist relative rotation between the adapter and the first object. In one embodiment, the curved band further includes at least one of a first radially inwardly extending lip disposed at the front circumferential side and a second radially inwardly extending lip disposed at the rear circumferential side,

such that, upon fitting the curved band over the generally cylindrical portion of the first object, axial movement of the adapter relative to the first object is resisted by at least one of the first lip and the second lip. In one embodiment, each of the plurality of grooves includes a cross-sectional profile including a curved portion defining a radius of curvature of about 1 inch to about 2 inches. In one embodiment, at least one of the plurality of grooves further includes a tab disposed at the front circumferential side and projecting radially inwardly, the tab being configured to engage a surface of the first object to resist axial displacement of the adapter in a direction from the front circumferential side toward the rear circumferential side. In one embodiment, at least one land disposed between two consecutive grooves further includes a tab disposed at the rear circumferential side and projecting radially inwardly, the tab being configured to engage the first object to resist axial displacement of the adapter in a direction from the rear circumferential side toward the front circumferential side. In one embodiment, the plurality of grooves includes about 2 to about 25 grooves. In one embodiment, a ratio of a circumference of the opening to a circumference of the curved band is about 190 degrees/170 degrees or 1.1 to about 310 degrees/50 degrees or 6.2. In one embodiment, the first object includes a rotatable clutch adjustment ring of a handheld drill.

In accordance with the present invention, there is provided a tree-tapping tool assembly configured to be mounted to a handheld drill having a drill bit with a central axis, the tree-tapping tool assembly including:
(a) an adapter configured to be mounted on a generally cylindrical portion of the handheld drill;
(b) an adjustable ring secured to the adapter;
(c) a front plate disposed distally from the adjustable ring and defining an aperture through which the drill bit extends;
(d) a plurality of surface-engaging members disposed on the front plate and configured to contact a tree surface; and
(e) a spacing structure extending between the adjustable ring and the front plate and configured to maintain a selectable distance between the front plate and the adjustable ring,
wherein the adapter is interposed between the handheld drill and the adjustable ring such that the adjustable ring is secured to the handheld drill by way of the adapter.

In one embodiment, the adapter includes a curved band defining an opening and having an inner surface and an outer surface. In one embodiment, the adapter further includes a step-down portion disposed on and extending circumferentially about the outer surface of the curved band, the adjustable ring being secured over the step-down portion. In one embodiment, the adapter further includes a plurality of grooves disposed on the inner surface of the curved band. In one embodiment, the plurality of grooves extend axially between opposite circumferential sides of the curved band and are configured to permit radial flexure of the curved band to facilitate conforming engagement with the generally cylindrical portion of the handheld drill. In one embodiment, at least one of the plurality of grooves is configured to receive a rib disposed on the generally cylindrical portion of the handheld drill to resist relative rotation between the adapter and the handheld drill. In one embodiment, the adapter further includes at least one of a first radially inwardly extending lip disposed at a front circumferential side of the curved band and a second radially inwardly extending lip disposed at a rear circumferential side of the curved band, such that axial movement of the adapter relative to the handheld drill is resisted by one of the first lip and the second lip. In one embodiment, the spacing structure includes at least one slide extending between the adjustable ring and the front plate and configured to permit relative axial movement therebetween. In one embodiment, the at least one slide includes a spring-loaded slide configured to bias the front plate away from the adjustable ring. In one embodiment, the generally cylindrical portion of the handheld drill is a rotatable clutch adjustment ring configured to vary a torque threshold of the handheld drill.

An object of the present invention is to provide a device to easily separate the two parts of a spout or spile so one or both of the parts can be replaced.

Another object of the present invention is to provide a device to easily separate the two parts of a spout or spile so one or both of the parts can be replaced without severing and shortening the attached hose.

Another object of the present invention is to provide a device to easily separate the two parts of a spout or spile one or both of the parts can be replaced to prevent bacterial contamination of the sap and to preserve the health of maple trees by minimizing the need for new holes to be tapped in the trees when tap holes are plugged with debris.

Another object of the present invention is to provide a device to easily separate the two parts of a spout or spile so they can be completely removed from the tree for cleaning or replacement.

Another object of the present invention is to provide an adapter configured to enhance the securement of a tree-tapping tool to a handheld drill by improving conformity between the tool and varying drill geometries.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top front perspective view of a device configured to be adaptable to a drill;

FIG. 2 is a top rear perspective view of a device configured to be adaptable to a drill;

FIG. 3 is a top view of a device configured to be adaptable to a drill;

FIG. 4 is a front view of a device configured to be adaptable to a drill;

FIG. 5 is a side view of a device configured to be adaptable to a drill, depicting a front plate of the device being disposed in a second position;

FIG. 6 is a side view of a device configured to be adaptable to a drill, depicting a front plate of the device being disposed in a first position;

FIG. 7 is a side view of a device configured to be adaptable to a drill, depicting a front plate of the device being disposed in a third position;

FIG. 8 is a top front perspective view of a device configured to be adaptable to a drill, depicting an additional tool useful for marking a tree at or around the same time the tree is drilled;

FIG. 9 is a top front perspective view of a second device useful for maintenance related to the tapping of a maple tree, depicting the second device being disposed in a position to separate a spout in preparation for its replacement with a new spout;

FIG. 10 is a top front perspective view of the device of FIG. 9 disposed in a manner such that it is useful as a hammer or a claw;

FIG. 11 is a side perspective view of the device of FIG. 9 disposed in a manner such that it is useful as a hammer or a claw;

FIG. 12 is a bottom perspective view of the device of FIG. 9 disposed in a manner such that it is useful as a hammer or a claw;

FIG. 13 is a bottom front perspective view of the device of FIG. 9 disposed in a manner useful as a claw;

FIG. 14 is a top side perspective view of the device of FIG. 9 disposed in a manner useful as a hammer;

FIG. 15 is a diagram depicting a manner in which a spout is used to communicate tree sap to a hose;

FIG. 16 is a diagram depicting the jaws of the device of FIG. 9 surrounding the attachment interface of an attached unit formed of a stubby spout and a check valve adapter;

FIG. 17 is a diagram depicting the jaws of the device of FIG. 9 as shown in FIG. 14 when the jaws of the device continue to be closed to engage the attached unit before separating the attached unit into two parts as shown elsewhere herein;

FIG. 18 is a diagram depicting the jaws of the device of FIG. 9 upon having separated a stubby spout from a check valve adapter of an attached unit;

FIG. 19A is a side perspective view of a first adapter axially aligned with a front end of a handheld drill, ready to be slid over a clutch adjustment ring of a first drill model;

FIG. 19B is a side perspective view of the first adapter mounted on the drill shown in FIG. 19A, with the first adapter positioned over the clutch adjustment ring of the first drill model;

FIG. 19C is a partial front perspective view of a first adapter-installed first drill model, illustrating a front circumferential end of a curved band and a plurality of grooves disposed thereon;

FIG. 19D is a side perspective view of a tree-tapping tool mounted over the first adapter that is already mounted to the first drill model, illustrating the adapter secured to a generally cylindrical portion of the drill;

FIG. 20A is a rear perspective view of a first adapter illustrating a rear circumferential side of the curved band;

FIG. 20B is a front perspective view of a first adapter illustrating a front circumferential side of the curved band;

FIG. 20C is a front view of the first adapter;

FIG. 20D is a rear view of the first adapter;

FIG. 20E is a rear side cross-sectional view of the first adapter illustrating a step-down portion disposed on an outer surface of the curved band;

FIG. 21A is a partial side cross-sectional view of a first adapter illustrating structural features including a front lip and a rear lip, and depicting the first adapter aligned to be secured to a clutch adjustment ring of a drill;

FIG. 21B is a partial side cross-sectional view of the first adapter of FIG. 21A after being secured to the clutch adjustment ring, depicting an annular groove and a rounded annular shoulder disposed on an outer surface of the clutch adjustment ring;

FIG. 22A is a side perspective view of a first adapter axially aligned with a front end of a handheld drill, ready to be slid over a clutch adjustment ring of a second drill model;

FIG. 22B is a side view of the first adapter mounted on the drill shown in FIG. 22A, with the first adapter positioned over the clutch adjustment ring of the second drill model;

FIG. 22C is a front perspective view of the adapter, illustrating a front circumferential end of a curved band and a plurality of grooves disposed thereon;

FIG. 22D is a front perspective view of a tree-tapping tool mounted over a first adapter that is already mounted to the second drill model, illustrating the first adapter secured to a generally cylindrical portion of the drill;

FIG. 23A is a side perspective view of a first adapter axially aligned with a front end of a handheld drill, ready to be slid over a clutch adjustment ring of a third drill model;

FIG. 23B is a side view of the first adapter mounted on the drill shown in FIG. 23A, with the first adapter positioned over the clutch adjustment ring of the third drill model;

FIG. 23C is a front perspective view of the first adapter, illustrating a front circumferential end of a curved band and a plurality of grooves disposed thereon;

FIG. 23D is a front perspective view of a tree-tapping tool mounted over a first adapter that is already mounted to the third drill model, illustrating the first adapter secured to a generally cylindrical portion of the drill;

FIG. 24A is a front perspective view of a second adapter illustrating a front circumferential side of the curved band;

FIG. 24B is a rear perspective view of a second adapter illustrating a rear circumferential side of the curved band;

FIG. 24C is a rear side cross-sectional view of a second adapter illustrating a step-down portion disposed on an outer surface of the curved band, wherein the cross-section is taken through one of the plurality of grooves formed on the inner surface of the curved band;

FIG. 24D is a rear side cross-sectional view of a second adapter illustrating a step-down portion disposed on an outer surface of the curved band;

FIG. 25A is a side perspective view of a second adapter axially aligned with a front end of a handheld drill, ready to be slid over a clutch adjustment ring of a fourth drill model;

FIG. 25B is a side perspective view of the second adapter mounted on the drill shown in

FIG. 25A, with the second adapter positioned over the clutch adjustment ring of the fourth drill model;

FIG. 25C is a side perspective view of a tree-tapping tool mounted over the second adapter that is already mounted to the fourth drill model, illustrating the adapter secured to a generally cylindrical portion of the drill;

FIG. 26A is a side perspective view of a third adapter axially aligned with a front end of a handheld drill, ready to be slid over a clutch adjustment ring of a fifth drill model;

FIG. 26B is a side perspective view of a tree-tapping tool mounted over the third adapter that is already mounted to the fifth drill model, illustrating the adapter secured to a generally cylindrical portion of the drill;

FIG. 27A is a front perspective view of a third adapter illustrating a front circumferential side of the curved band;

FIG. 27B is a rear perspective view of a third adapter illustrating a rear circumferential side of the curved band;

FIG. 27C is a front side cross-sectional view of a third adapter illustrating a step-down portion disposed on an outer surface of the curved band; and

FIG. 27D is a front side cross-sectional view of a third adapter illustrating a step-down portion disposed on an outer surface of the curved band, wherein the cross-section is taken through one of the plurality of grooves formed on the inner surface of the curved band.

### PARTS LIST

2—maple tree tapping tool or device
4—drill or handheld tool, e.g., power tool, cordless power drill
6—drill bit
8—front plate
10—aperture
12—locator pin
14—point of locator pin
16—body or adjustable ring
18—slide, e.g., spring-loaded slide
20—rod
22—linear motion bearing
24—block
26—latch
28—slot
30—lever or trigger
32—fastener
34—paint marker
36—paint marking tip
38—spout separating or removal tool or device
40—first shank
41—second shank
42—first jaw
43—second jaw
44—pivot point
45—pin
46—striking head
48—claw
49—stubby spout
50—check valve adapter
51—hose
52—central axis of block
54—central axis of drill bit
56—central axis of slide
58—opening
60—tree surface
62—drilled hole
64—direction in which drill is pressed against surface
66—first position of front plate relative to body
68—second position of front plate relative to body
70—third position of front plate relative to body
72—portion of front plate where latch can be engaged
74—opening
76—contour of tree trunk
78—first cutout
80—second cutout
82—stop
84—cutout
86—leading edge of first jaw
88—leading edge of second jaw
90—hose coupler
92—check valve adapter tap
94—stubby spout taper
96—attachment interface
98—hanging hole
100—tree bark
102—sapwood
104—chuck
106—rotatable clutch adjustment ring of handheld tool, configured to vary a torque threshold
108—transmission housing
110—motor housing
112—trigger switch
114—handle
116—battery receptacle
118—battery
120—adapter
122—curved band
123—stop
124—step-down or clamping portion
126—groove
128—land
130—front lip
132—rear lip
134—rounded annular shoulder
136—rear tab in land or groove
138—rib of first object
140—circumference of band
141—opening
142—circumference of opening
144—central axis of adapter
146—tapered front surface of adapter with respect to central axis
148—tapered rear surface of adapter with respect to central axis
150—central axis of drill
152—annular groove

### Particular Advantages of the Invention

The present device allows an attached unit formed of a stubby spout and a check valve adapter of a two-part spout to be separated to avoid requiring a hose connected to the spout, to be cut such that the two-part spout can be removed and discarded in its entirety. With the ability to remove a stubby spout from the check valve adapter it is attached to, the stubby spout is left connected to the hose, leaving the stubby spout reusable and the hose intact. Further, when the hose is left intact, there is no need to replace the hose as a cut hose would eventually become too short to connect to its collection system after several cuttings over several seasons.

The shanks of the present device are used to apply a force at a set of closing jaws to separate the two-part spout. In its stacked form, the shanks serve as a handle for a striking head, thereby providing the same shanks additional utility as a striking tool. The present device further includes a claw configured to remove a spout from a maple tree. These combined features of the present device negate the need for multiple segregated tools to be transported to site.

In certain embodiments, the present invention further includes an adapter configured to be interposed between a handheld drill and an adjustable ring of a tree-tapping tool. The adapter provides a defined outer mounting interface for receiving the adjustable ring while conforming to a generally cylindrical portion of the drill. By improving conformity between the drill and the adjustable ring, the adapter enhances resistance to relative rotation or movement during operation, thereby promoting stable drilling performance.

In some embodiments, the adapter includes structural features configured to accommodate variations in drill geometry, including differences in diameter, surface contour, and rib configuration among various drill models. This adaptability allows a single tree-tapping tool configuration to be used with multiple drills without requiring modification of the primary tool structure.

In certain embodiments, the adapter further resists axial displacement relative to the drill once installed, thereby maintaining a consistent positional relationship between the drill and the tree-tapping tool during repeated use. Improved securement may reduce the likelihood of loosening under torque and may contribute to more predictable drilling depth and alignment.

The adapter may also permit controlled radial flexure during installation, allowing it to conform to surface irregularities while maintaining sufficient rigidity to support the adjustable ring. By providing an intermediary mounting structure, the adapter enhances compatibility and stability while preserving the intended functionality of the drill and the tree-tapping tool.

### Detailed Description of a Preferred Embodiment

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

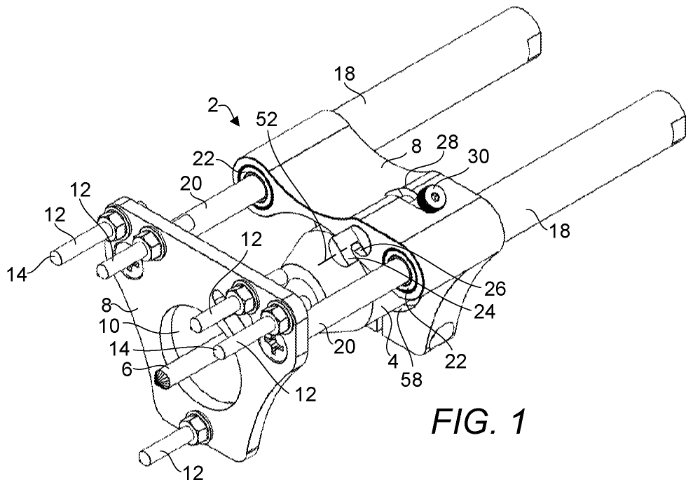

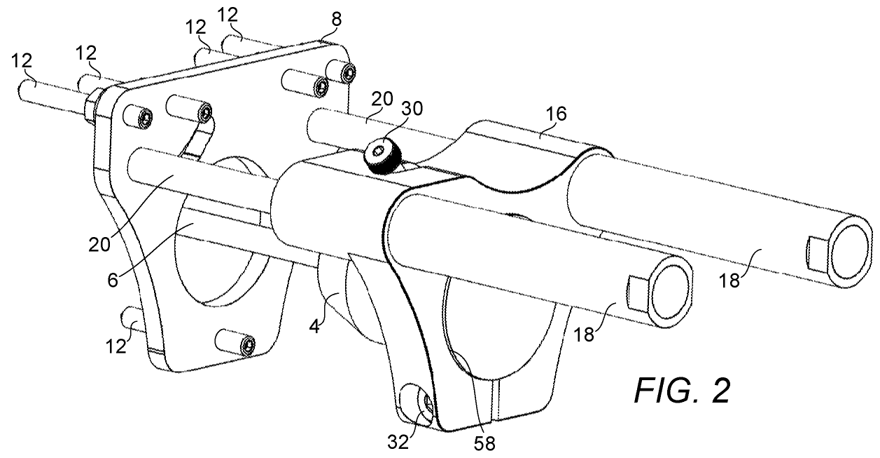

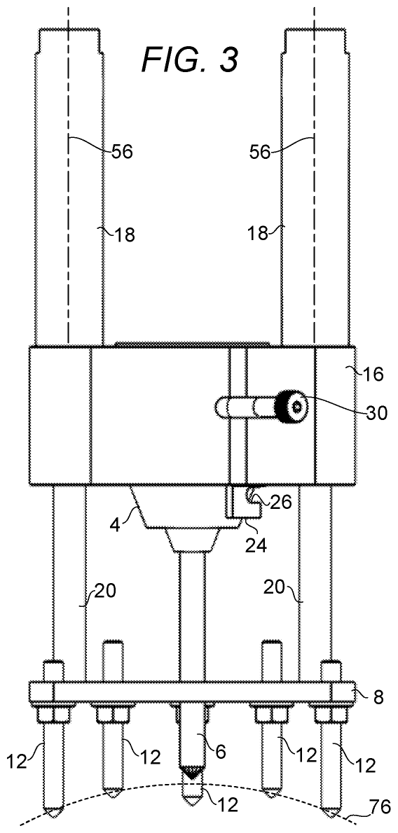

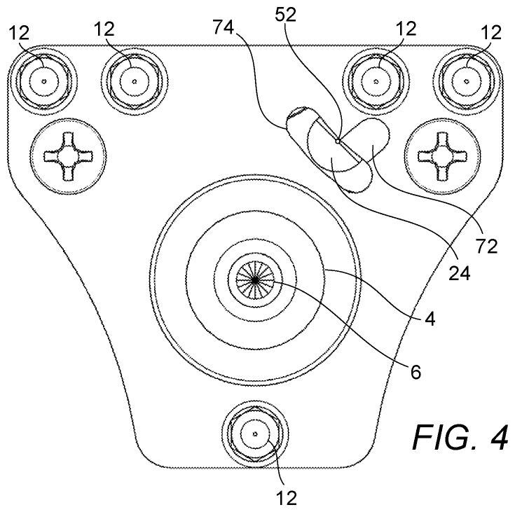

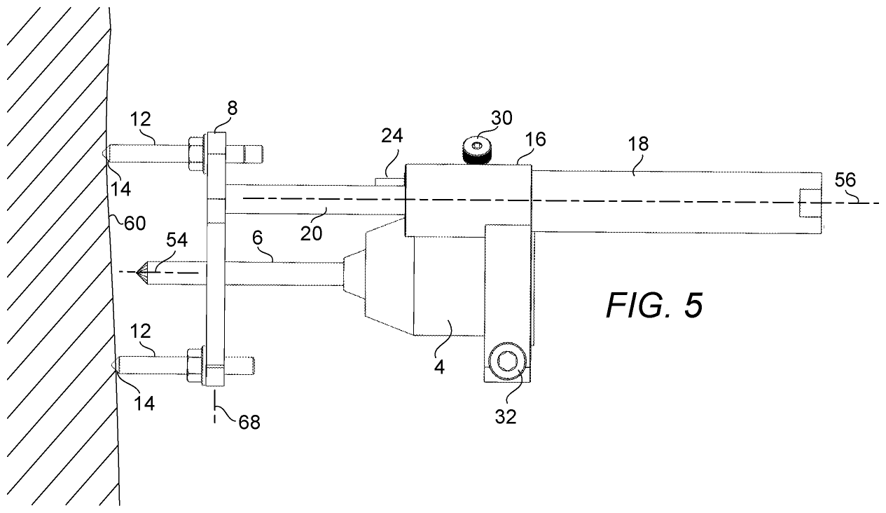

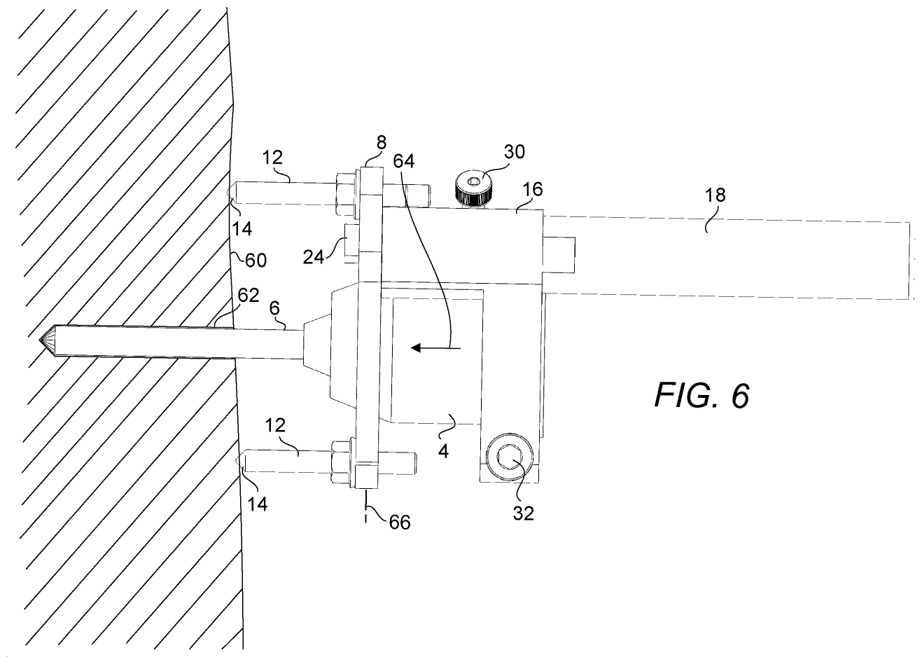

FIG. 1 is a top front perspective view of a device 2 configured to be adaptable to a drill 4. FIG. 2 is a top rear perspective view of a device 2 configured to be adaptable to a drill 4. FIG. 3 is a top view of a device 2 configured to be adaptable to a drill 4. FIG. 4 is a front view of a device 2 configured to be adaptable to a drill 4. It shall be noted that, in these and the ensuing drawings, only a portion of a drill is shown. The device 2 is configured to be adapted to a drill 4. The drill 4 has a drill bit 6 and the drill bit 6 has a central axis 54. The device 2 includes an adjustable ring 16, a front plate 8, a plurality of pins 12 and at least one slide 18, e, g., as shown herein. The adjustable ring 16 is configured to be adapted to the drill 4 where the adjustable ring 16 is disposed at a proximal end of the device 2. In use, the adjustable ring 16 is slid over a stationary area of a suitable drill 4 just behind the chuck and secured to this area of the drill 4. A suitable drill is one which is handheld and electrically-powered either with an electrical cord or with a portable battery. In the embodiment shown, the adjustable ring 16 is a split ring including an opening 58 sized sufficient to be slid over this area where the diameter of the opening 58 is configured to be adjustable by using a fastener 32, e.g., a screw, etc., which secures the two parts of the split ring 16 and can be tightened around the area, securing the ring 16 to the drill 4. The front plate 8 is disposed at a distal end of the device 2 and includes an aperture 10 through which the drill 4 is accommodated. The plurality of pins 12 are disposed on the front plate 8, each pin 12 including a tip 14, e.g., a pointed tip to provide grip while the pins 12 are engaging a tree trunk surface, e.g., tree bark. In the embodiment shown, each pin 12 is configured to be adjustable with respect to the front plate by using a screw and nut combination. Screw threads are disposed on each pin and matching threads are tapped in holes configured for receiving these pins in the front plate 8. Upon adjustment, each pin is secured in place by means of a nut. In this embodiment, two slides 18 are used, each having a central axis 56, although one slide may be sufficient. The use of more than one slide increases the ability of the device to resist the torque created while drilling, ultimately resulting in more precise holes that are drilled. A precise hole is defined as a dimensionally-predictable hole in which a spout fits well to allow sap collection without fail. The front plate 8 is configured to be retractable to a first position 66 as shown in FIG. 6 and extendable to a second position 68 as shown in FIG. 5. The adjustable ring 16 is attached to each slide 18 at a first portion of the slide 18 and the front plate 8 is attached to the slide 18 at a second portion of the slide and a distance between the tip of each pin 12 and the adjustable ring is configured to be adjustable by the slides 18 along the central axis 56 of the at least one slide 18. A slide can be a spring-loaded slide. In the embodiment shown, each slide is essentially a rod 20 configured to travel relative to a cylindrical housing. Within the cylinder, a head end of the rod 20 is disposed in a manner to contact one end of a mechanical spring. The travel of the rod relative to the cylinder is facilitated by a linear motion bearing 22 which also serves as a seal to prevent debris from getting into the cylinder, thereby promoting the longevity of the slide. Alternatively, a slide may include an air spring instead. An appropriate spring rate is selected to require an appropriate level of engagement force to be applied to the slide before the slide can be compressed. Care must be taken to allow a user to sense that the pins 12 have come in contact with a tree trunk and that the device 2 has properly engage it before the user continues to move the device towards the tree in direction 64 to compress the slides 18 to allow the drill to reach the tree trunk such that an elongated cylindrically-shaped hole 62 can be created before a spout can be subsequently inserted. Care must also be taken to ensure that the amount of force needed to compress the springs is sufficiently low for an average user.

The device further includes a lock configured for locking the slides 18 to substantially a first position. In this position, functions rendered by the device 2 for maple tree tapping is suppressed, allowing the drill to be used for purposes originally intended for the drill, e.g., for a broken spout or tap to be drilled out and removed. As such, while the device is attached to a drill, the drill can still be used for other purposes by simply disposing the device in the locked or first position or with the front plate out of the way of the drill bit. In the embodiment shown throughout the figures, it shall be noted that the lock is essentially a barrel rotatably housed in the body 16 where the barrel is capable of rotation about a central axis 52. A trigger 30 is attached to the barrel and disposed at a location of the device such that the barrel is operable by a user while holding the drill by rotating the barrel to an orientation where a block 24 disposed at one end of the barrel is disposed at an orientation with a latch 26 of the block 24 either engaging or disengaging a portion 72 of the front plate 8. A slot 28 made in the body 16 allows the trigger 30 to protrude from the body 16 such that it is accessible to the user. If the latch 26 is engaged with portion 72, the front plate 8 is locked in the first position. The front plate 8 can be released to resume its second position simply by removing this engagement.

FIG. 5 is a side view of a device configured to be adaptable to a drill, depicting a front plate 8 of the device being disposed in a second position 68 relative to the body 16. FIG. 6 is a side view of a device configured to be adaptable to a drill, depicting a front plate 8 of the device being disposed in a first position 66 relative to the body 16. In the position shown in FIG. 5, the device is ready to be used to drill an elongated hole in a maple tree having a surface 60. The device is positioned at a desired surface 60 through which an elongated hole is to be drilled with at least three of the tips 14 engaging the surface 60. Referring back to FIG. 3, it shall be noted that five pins are provided. The area encompassed by the engaging pins 12 are preferably as wide as possible for increased stability of the engagement. In other words, care should be taken to ensure that the pins 12 disposed on the periphery of the area should be adjusted to lengths sufficient to allow their engagements with the surface 60. The pins 12 disposed within the area of engagement delineated by the peripheral pins 12 are preferably adjusted to shorter lengths from the front plate 8 as shown in FIG. 3 to allow them to conform to a contour 76 of a tree trunk. Upon seating the pins 12 against a tree trunk as shown in FIG. 5, a user of the drill 4 can proceed to push the device towards the surface upon which an elongated hole is to be made as shown in FIG. 6. It shall be noted that as the slides 18 and the drill bit 6 are not coaxially disposed as evidenced in the central axis 54 of the drill that is not being coaxially disposed with any one of the central axes 56 of the slides 18, the device assumes an open structure with the bottom space of the drill largely uninhibited, eliminating any opportunity for the device to collect debris as in the case of a device with a cage-like structure.

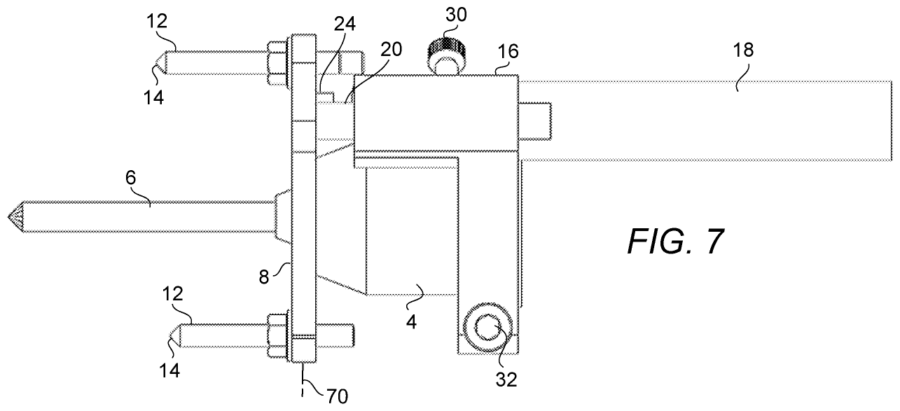

FIG. 7 is a side view of a device configured to be adaptable to a drill, depicting a front plate 8 of the device being disposed in a third position 70 relative to the body 16. It shall be noted that the block 24 shown in FIG. 4 as being disposed in an opening 74 of the front plate 8 is now disposed at an orientation preventing the block 24 from being disposed in the opening 74, thereby creating an offset compared to the first position where the block 24 is disposed at least partially in the opening 74 to latch on to portion 72 of the front plate 8. It shall be noted that, in the embodiment shown throughout, the lock serves dual purposes, both as a lock and as a block to limit the retraction of the front plate 8 to a position that is different from first position, thereby providing an alternative position or drilling depth to the device.

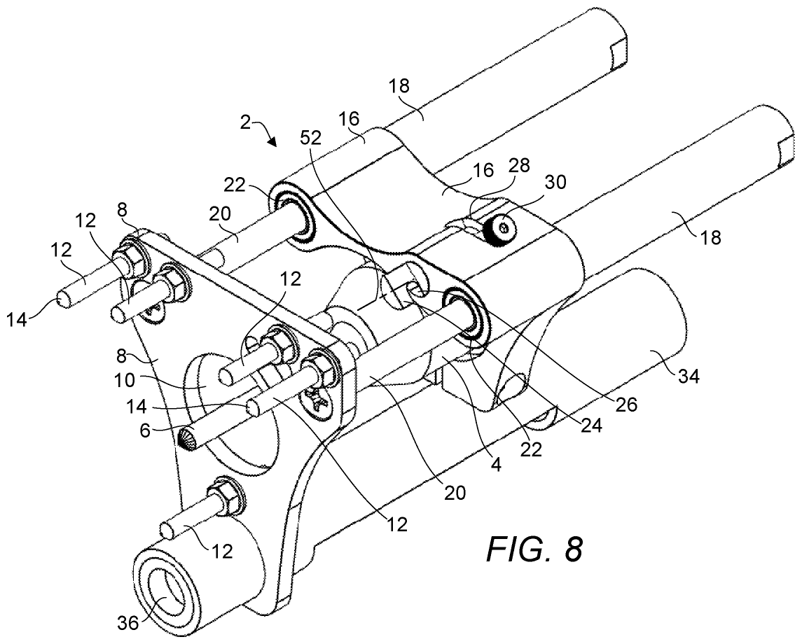

In some applications, maple trees are marked once they have been tapped to avoid tapping the same trees more than once in a maple-tapping season. Conventionally, the tapped maple trees are marked with some form of marker, e.g., paint in a process separate from the tapping activity. FIG. 8 is a top front perspective view of a device configured to be adaptable to a drill, depicting an additional tool useful for marking a tree at or around the same time the tree is drilled. Here, the device further includes a paint marker 34 configured to mark a portion of the surface at a moment a drill is pushed against the surface to be drilled. As the device is pushed against a surface to be drilled, a paint marker tip 36 of the paint marker 34 approaches the surface and eventually making contact with the surface to mark the surface with some paint. In this embodiment, as the device includes both a tapping tool and a marker, the process of tapping each tree using this device includes drilling and marking of the tree simultaneously, eliminating the need to mark the tree separately.

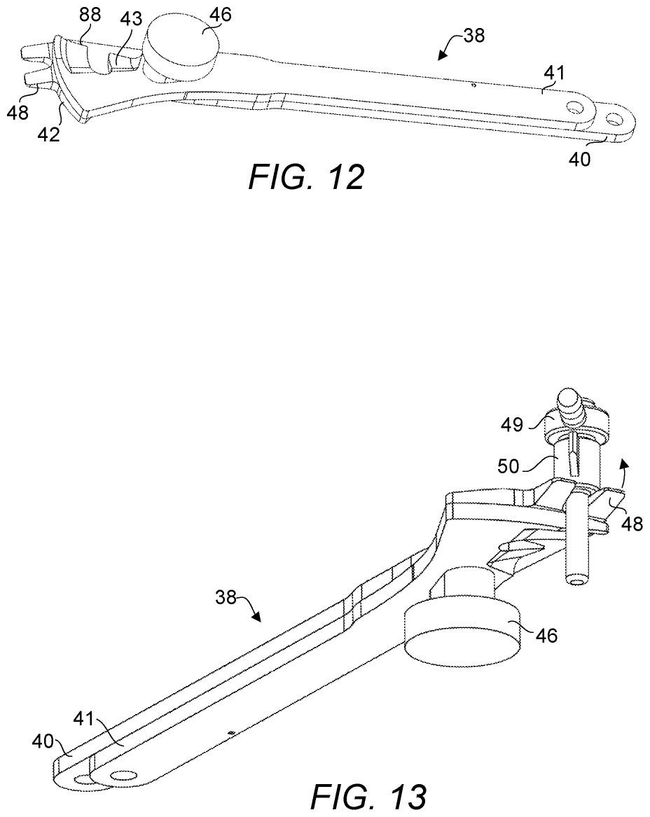

Sap is typically collected using a vacuum hose system consisting of spouts inserted in bored holes in maple trees, and the hoses connected to the spouts are led to a central sap collection tank. Sap contamination is an on-going problem to be avoided, as are leaks. Spouts can be one piece or two pieces. In both configurations, one end of the spout is tapered with annular ribs that is driven in a bored hole in the tree. At the beginning of each tapping season, the part of the spout that was inserted into a tree is replaced to ensure proper sanitation of the tap hole. A used spout can put contaminants in the tree that greatly affect sap production. To remove a one-piece spout from a tree, the attached hose, connected to the spout with a tapered ribbed coupler end, will need to be cut since removal of the hose from the ribbed end is very difficult. This shortens the hose each season, and eventually requires the hose to be replaced when its length is too short to connect to the rest of the system. This increases operating and material costs. A better approach is now thought to use a two-part spout as shown in FIG. 13 where the spout includes a check valve adapter 50 with a tapered tap 92 that is inserted into a bored tree hole, and a mating stubby spout 49 with taper 94 that fits snuggly into a matching tapered hole in the end of the check valve adapter. The check valve prevents sap from getting drawn back into the tree, causing the tap hole to prematurely close up and reduce sap flow near the end of the season. At the end of the season the stubby spout with attached hose is removable from the check valve adapter, and the check valve adapter can be plugged and left in the tree or removed using the claw 48. Plugging the check valve adapter keeps wasps from building a mud nest in the open end. Removing the check valve adapter from the tree can be difficult and often results in breakage. After removal, the tree may begin to heal and close the hole requiring a new hole to be drilled at the start of the new season. This can threaten the health of the tree if too many holes are subsequently drilled in the same area of the tree.

It has been found, however, that sap production is greatly increased by boring a new hole and inserting a new check valve adapter at the start of the new season. The stubby spout with attached hose can be separated from the check valve adapter using the tool 38 at the end of the season, and cleaned and stored away for the next season. No portion of the hose or stubby spout is wasted, keeping operating and material costs to a minimum.

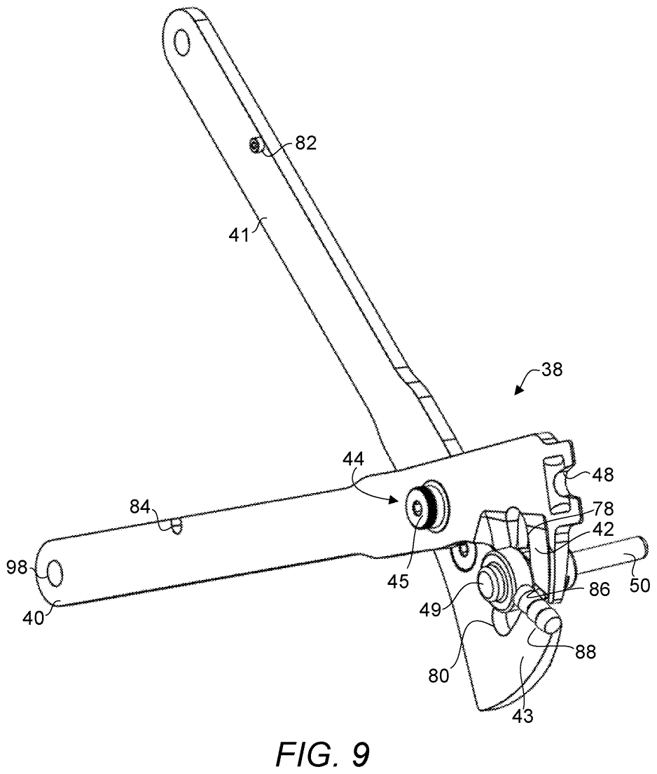

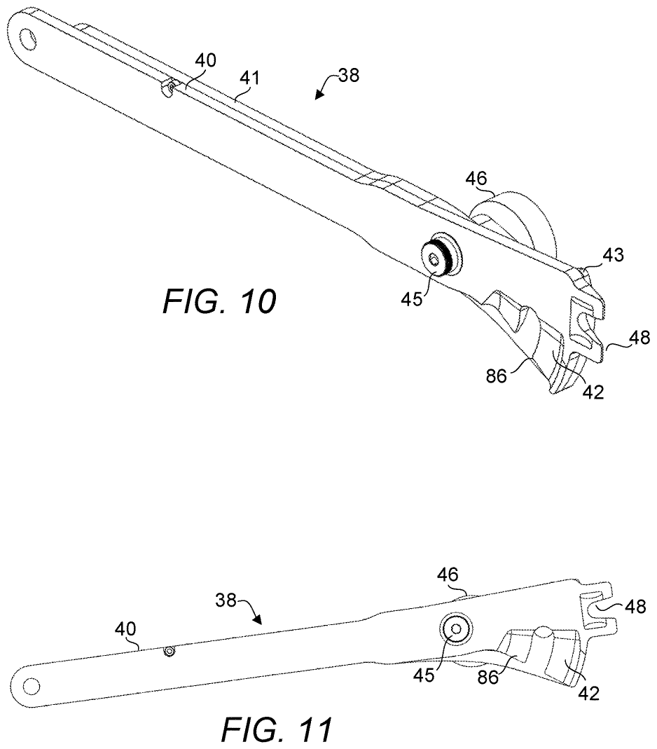

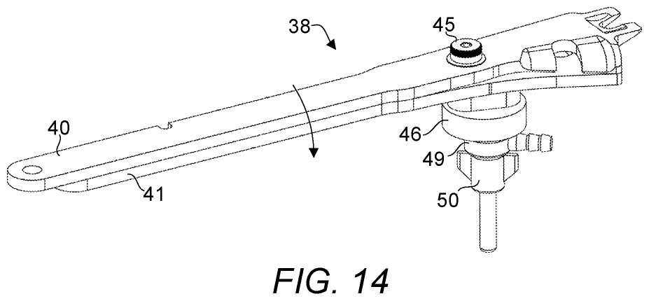

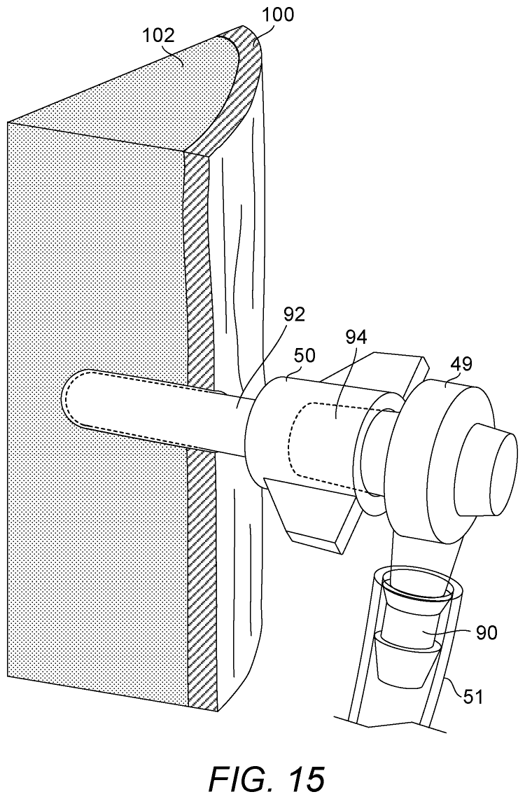

Upon setting up a tap for a maple tree, maintenance of the tap is required at a later time. At the beginning of each tapping season, the part of a spout that was inserted into a tree is replaced to ensure proper sanitation of the tap hole. A used spout can put contaminants in the tree that greatly affect sap production. In solving this problem, a combination of a spout adapter, e.g., a check valve adapter, and a stubby spout is used. A spout adapter is the part inserted into a tree and the stubby spout is connected at one end to a line that leads to a collection system and the other end to the spout adapter. It is challenging to separate the two parts, causing many maple syrup producers to avoid the two-part system. Disclosed herein is a second device 38 useful for separating spout parts, e.g., used, non-functioning or non-productive spout parts to make the two-part system more user friendly, e.g., easier to be separated and therefore more readily accepted with its user. The device 38 is useful for easily separating the two parts of this spout system by wedging them apart. The device 38 is also configured to be useful for replacing the spout before tapping, in which a hammer would be optimal to pair with the separator as one would first separate an old spout adapter from the stubby spout and then replace it with a new one, using the same tool to then tap it into a new hole drilled in a tree. With the two-part spout, the stubby spout can be reused, thereby removing the need to reconnect a hose to a new spout and to save a still useful part from being discarded. This device is also suitable for use to separate the two parts and to remove an old adapter at the end of a tapping season by pulling the spout out of the tree into which the spout has been inserted. In this case, a claw of the device is used to pry out the old spout before or after the two parts have been separated. FIG. 9 is a top front perspective view of a device useful for maintenance related to the tapping of a maple tree, depicting the device being disposed in a position to separate parts of a spout in preparation for its replacement with a new spout. FIG. 10 is a top front perspective view of the device of FIG. 9 disposed in a manner such that it is useful as a hammer or a claw 48, e.g., a beveled claw. FIG. 11 is a side perspective view of the device of FIG. 9 disposed in a manner such that it is useful as a hammer or a claw 48. FIG. 12 is a bottom perspective view of the device of FIG. 9 disposed in a manner such that it is useful as a hammer or a claw 48. The device is essentially a device which combines a spreader, a hammer and a claw in a single unit useful for removing and/or replacing at least a part of a spout. To facilitate the replacement of the part, the spout may not need to be removed in its entirety. The device includes a pair of plates, e.g., jaws 42, 43 which extend into shanks 40, 41 pivotably secured at a pivot point 44. In one embodiment not shown, the jaws 42, 43 may also be actuated using a mechanism according to principles of a parallel jaw mechanism where the jaws are disposed in parallel while they are being actuated. For separating a spout, the shanks 40, 41 are spread sufficiently far apart so that the jaws 42 and 43 can surround the tip of the spout at attachment interface 96 before the shanks 40, 41 are closed such that jaws 42 and 43 slide against each other to progressively exert a spreading force by contacting a portion of the stubby spout 49 and a portion of the adapter 50. A claw 48, useful for prying the portion of the spout left in a tap as shown in FIG. 13, is configured to extend from one of the jaws, e.g., jaw 42. The claw 48 may alternatively be configured to extend from jaw 43. A striking head 46 or striker is configured to be attached to one of the jaws as shown in FIG. 14, e.g., jaw 43, again providing an additional function to the device. The second shank 41 is configured to be stacked or overlapped with respect to the first shank 40 when the first jaw and the second jaw are disposed in the closed position as shown in FIGS. 10-12. It shall be noted that, the first jaw 42 includes a first thickness at the leading edge 86 of the first jaw 42 that is less prominent than a second thickness at a portion of the first jaw 42 away from the leading edge 86 of the first jaw 42. The second jaw 43 includes a similar cross-sectional profile albeit the cross-sectional profile is disposed in an opposite orientation to the cross-sectional profile of the first jaw 42. For instance, the second jaw 43 includes a first thickness at the leading edge 88 of the second jaw 43 that is less prominent than a second thickness at a portion of the second jaw 43 away from the leading edge 88 of the second jaw 43. It shall be noted that as the jaws 42, 43 are closed against one another, the contact points of the attached unit on the jaws 42, 43 become father apart, eventually resulting in insufficient friction between the two parts for the two parts to be held together. Although the change in thickness of a cross-sectional profile of a jaw 42, 43 can create this effect, a jaw having a consistent thickness can achieve a similar effect if it is orientated to mimic a taper of the cross-sectional profile.

The hammer is useful for more securely inserting a new spout or a replacement adapter in a tapped hole. The stacked shanks 40, 41 together serve as a handle for the device to be used as a claw or a hammer. In the embodiment shown, the striking head 46 is configured to be secured to the second shank 41 using a pin 45, e.g., a fastener, screw, etc., configured to pivotably connect the first shank 40 and the second shank 41. By disposing the striking head 46 at the pivot point, the rigidity of the striking head 46 as it is connected to the handle is enhanced.

The device further includes a stop 82, disposed on the second shank 41 to ensure that a handle has been properly formed when the stop 82 comes in contact with a cutout 84 disposed on the first shank 40. Although the stop 82 is shown disposed on the second shank 41, it can alternatively be disposed on the first shank 40 as long as the second shank includes a similar cutout as the one 84 disposed on the first shank 40 to accommodate the stop. Although not a requirement, the first jaw 42 and the second jaw 43 each includes a cutout 78, 80 disposed at the respective leading edge 86, 88 to surround the attachment interface 96 such that the jaws 42, 43 can act on the attachment interface 96 more securely. Further, with the cutouts, the taper in a jaw or plate does not need to be so severe as the cutout allows sufficient travel of the jaw with respect to a width of the attachment interface 96. The device 38 further includes a hanging hole 98 disposed at least on one of the first shank 40 and the second shank 41. In the embodiment shown, the first shank 40 is disposed in an extension exceeding that of the second shank 41, exposing the hanging hole 98 to facilitate the storage of the device by using a hook or to allow the device to be secured at the hanging hole 98 with a lanyard while allowing the device to be operable.

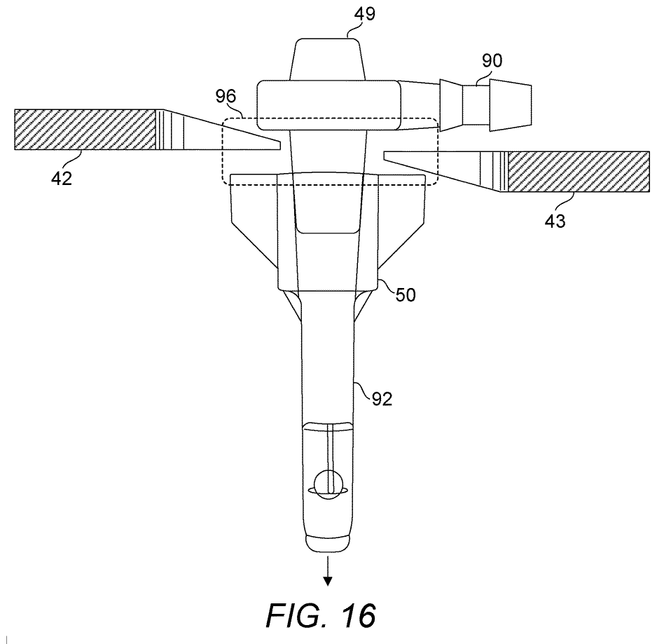

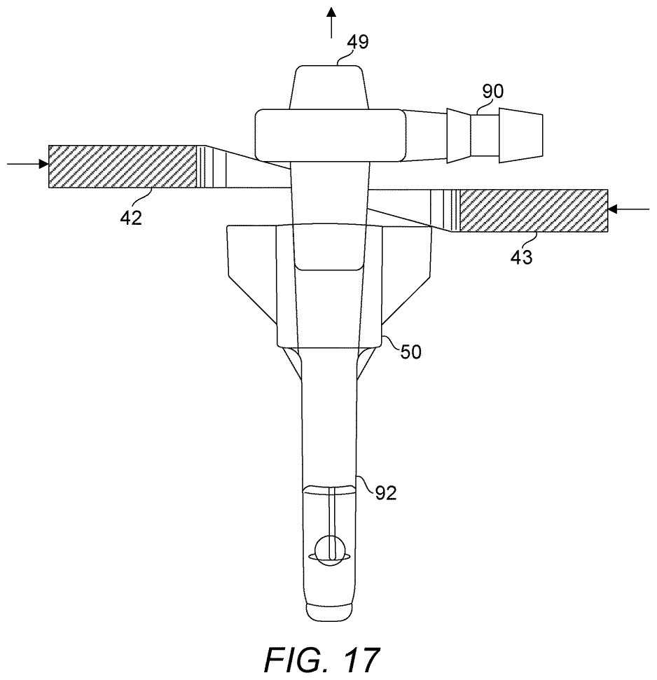

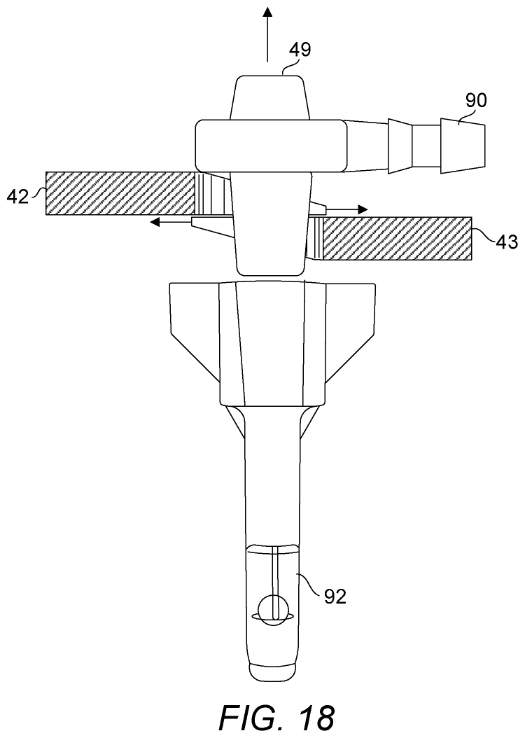

FIGS. 16, 17, and 18 depict a progression of separating a stubby spout from a check valve adapter using the tool of FIG. 9. FIG. 16 is a diagram depicting the jaws of the device of FIG. 9 surrounding the attachment interface 96 of an attached unit formed of a stubby spout 49 and a check valve adapter 50. FIG. 17 is a diagram depicting the jaws 42, 43 of the device of FIG. 9 as shown in FIG. 16 when the jaws 42, 43 of the device continue to be closed to engage the attached unit before separating the attached unit into two parts as shown elsewhere herein. FIG. 18 is a diagram depicting the jaws 42, 43 of the device of FIG. 9 upon having separated a stubby spout 49 from a check valve adapter 50 of an attached unit.

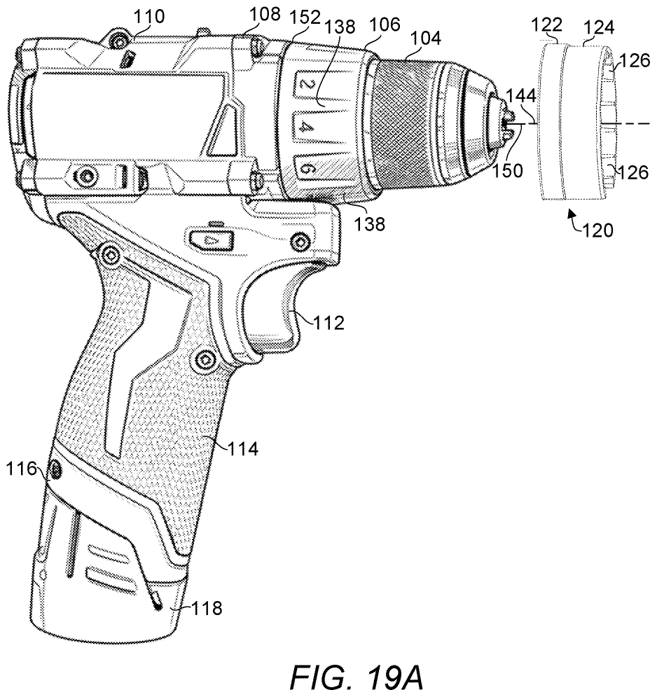

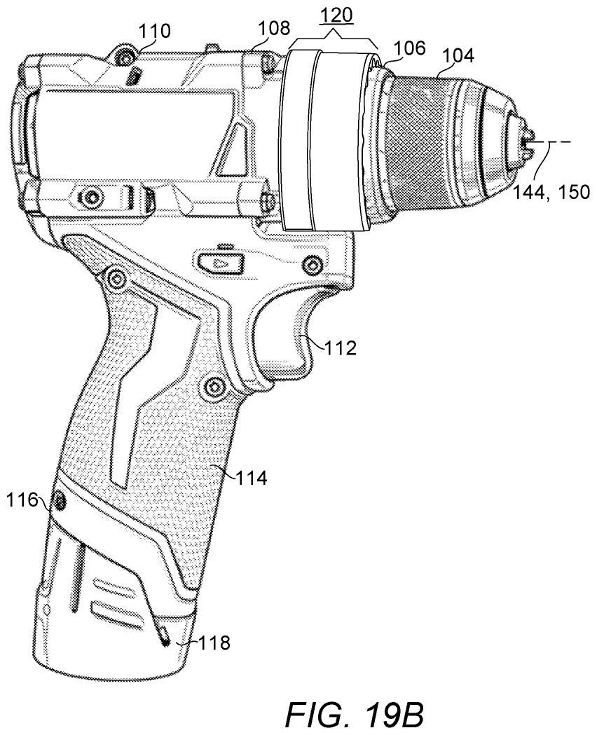

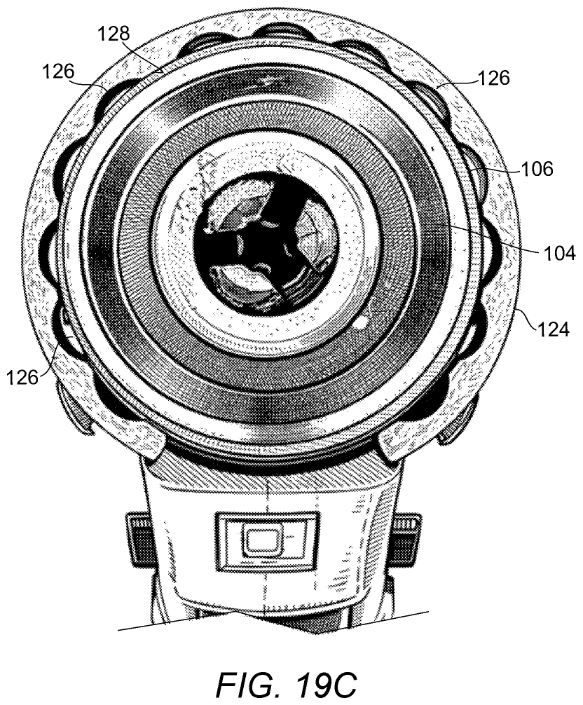

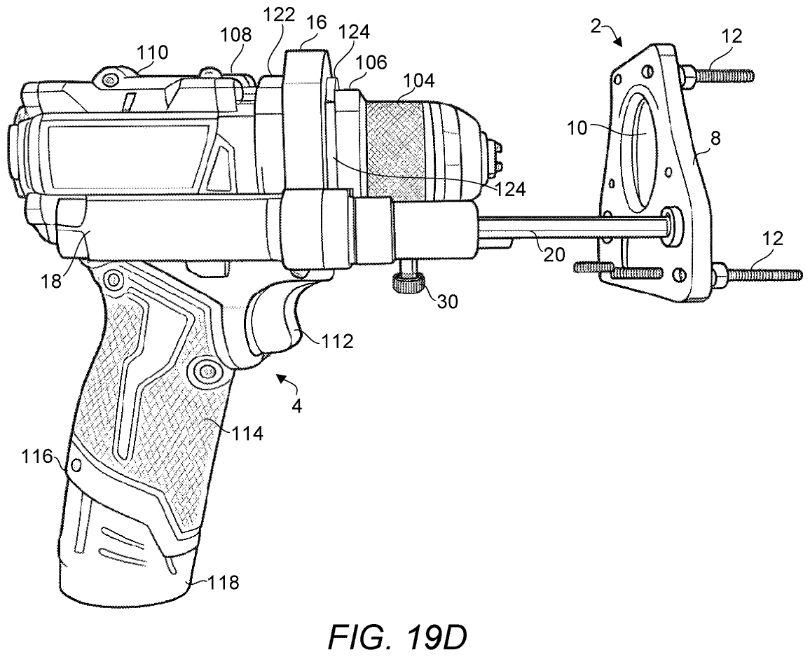

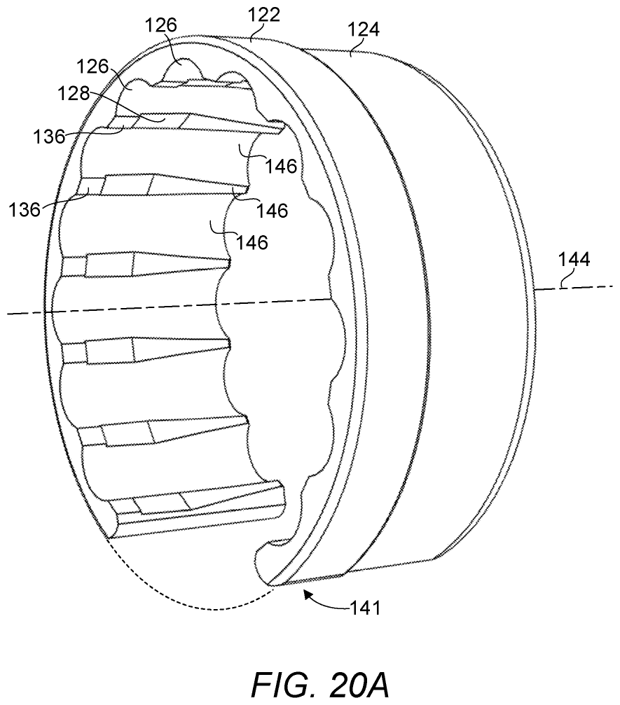

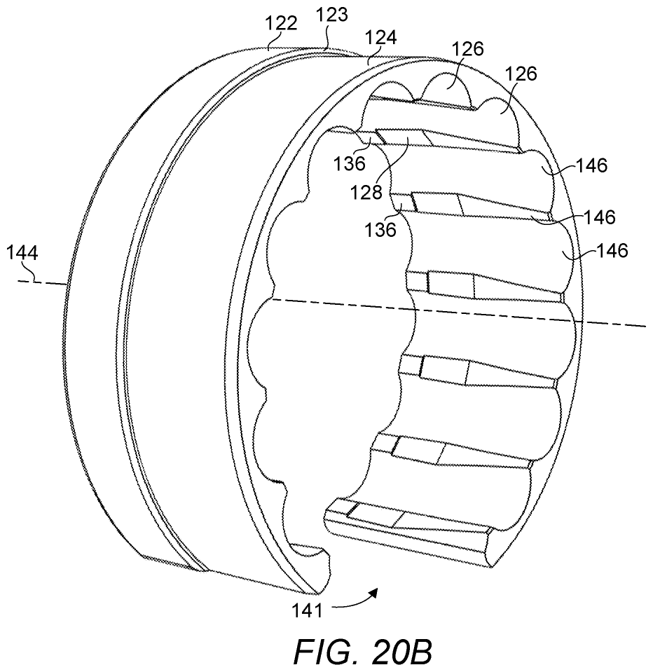

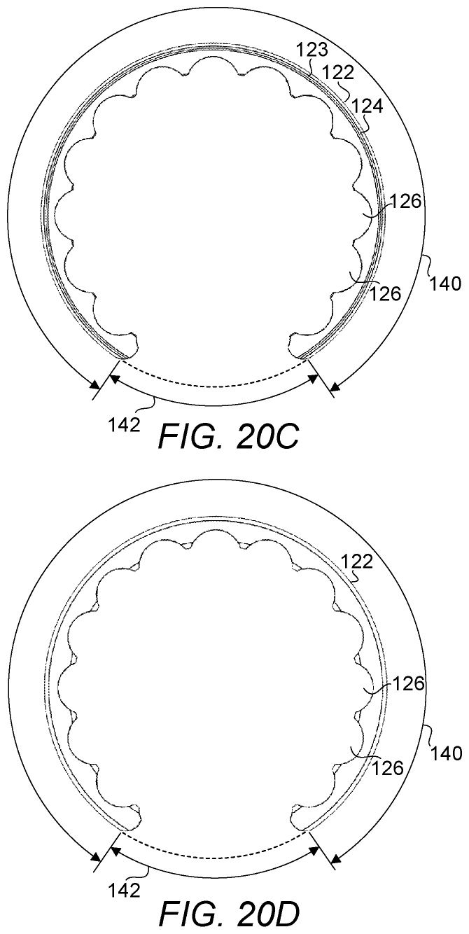

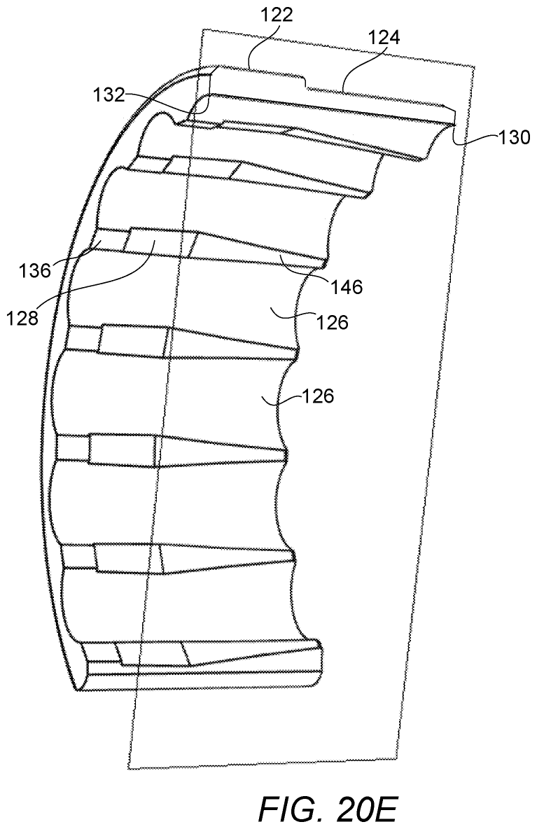

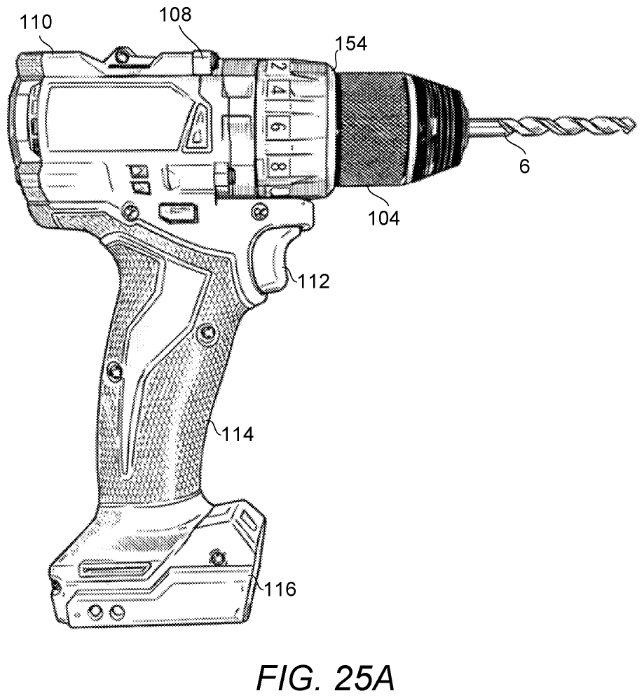

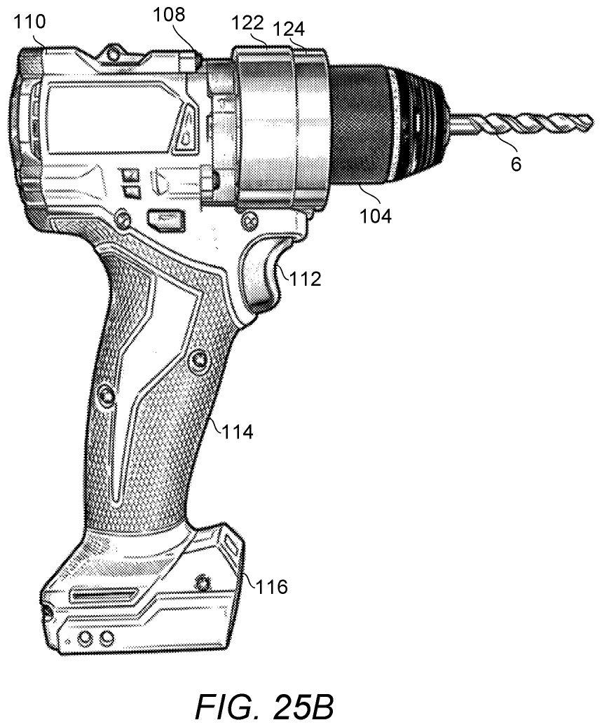

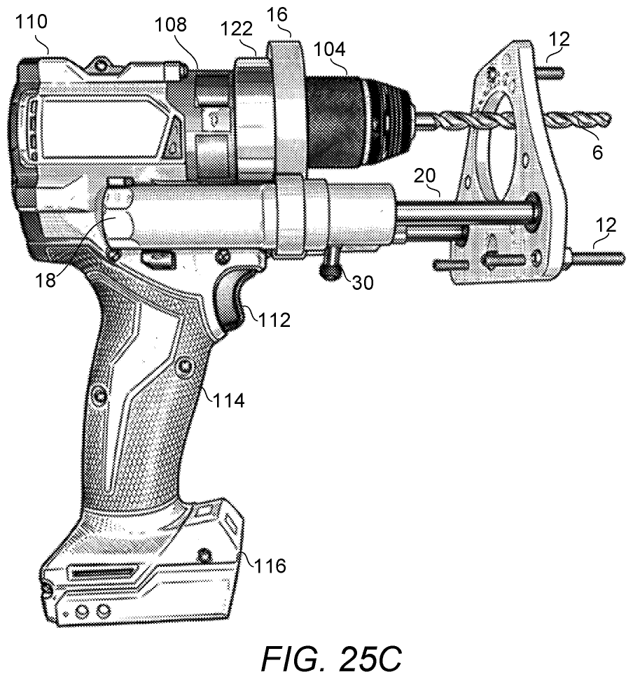

In certain embodiments, the present invention further includes an adapter 120 configured to be interposed between the handheld drill 4 and the adjustable ring 16 of the tree-tapping tool 2. While the adjustable ring 16 may in some instances be secured directly to a generally cylindrical portion of the drill 4, variations in drill geometry among different manufacturers and models may influence the degree of conformity and securement achievable through direct attachment. The adapter 120 provides an intermediary mounting structure configured to engage a generally cylindrical portion of the drill 4, the generally cylindrical portion including a portion of the drill that does not require user adjustment and remains stationary relative to other drill components, e.g., a handle 114 of the drill 4, during operation, and to present a defined outer surface for receiving the adjustable ring 16. By introducing the adapter 120 as an intermediate component, securement of the tree-tapping tool 2 to the drill 4 may be enhanced and compatibility across multiple drill models may be increased. Embodiments of the adapter 120 and its integration with various drill models are illustrated in FIGS. 19A-27D and described in greater detail elsewhere herein.

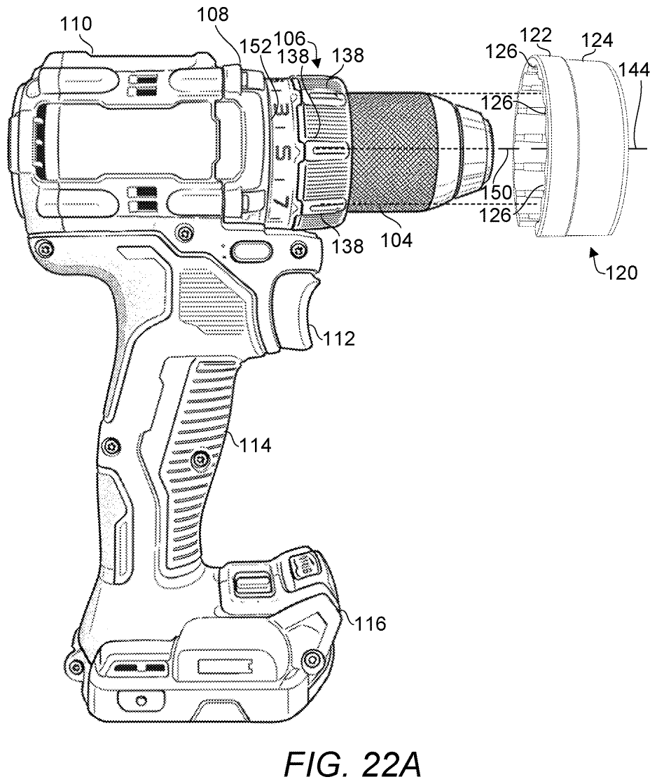

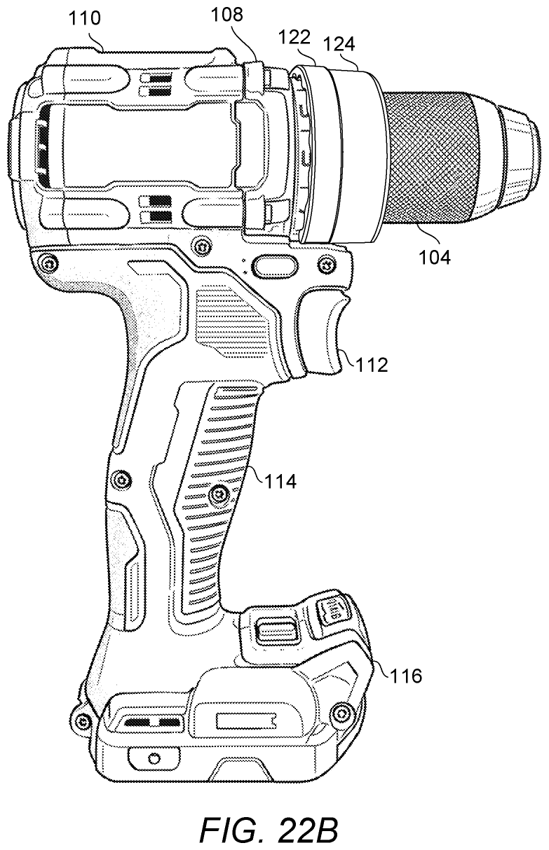

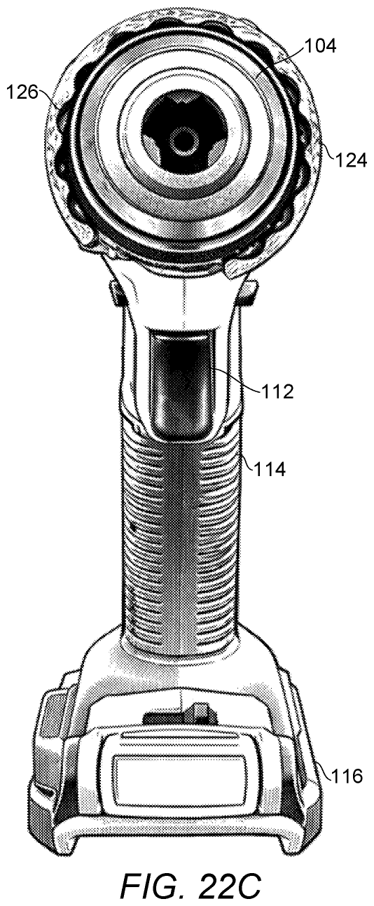

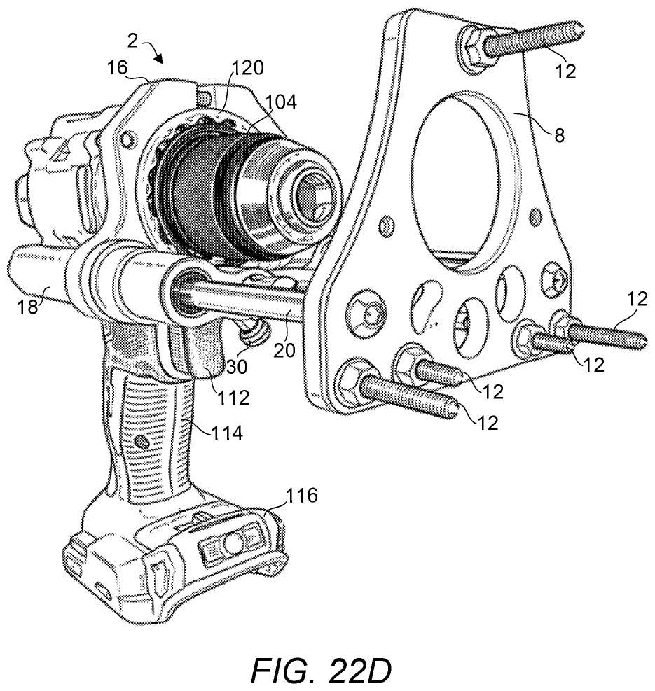

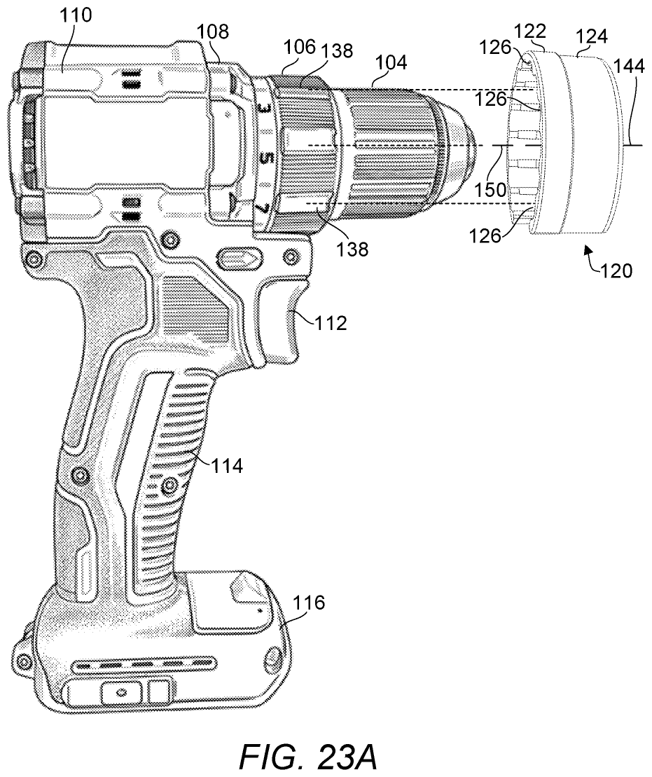

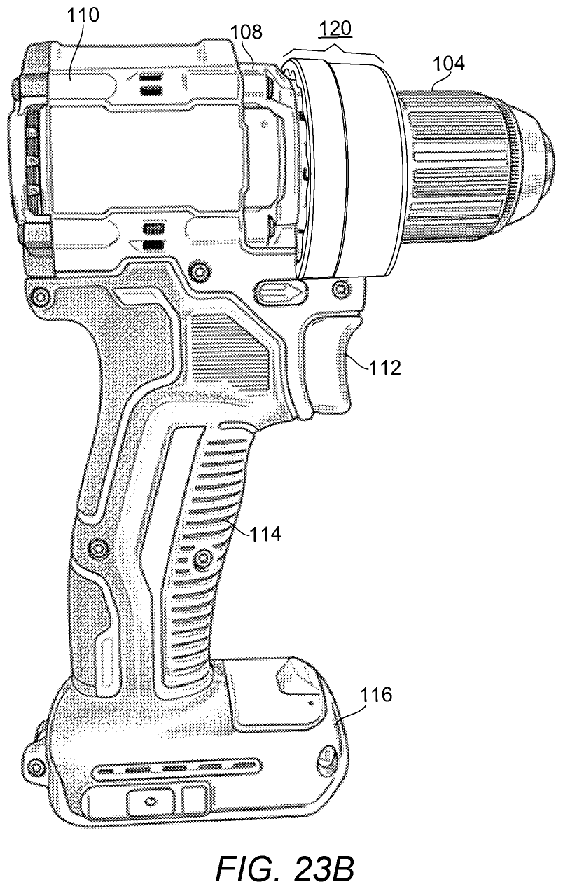

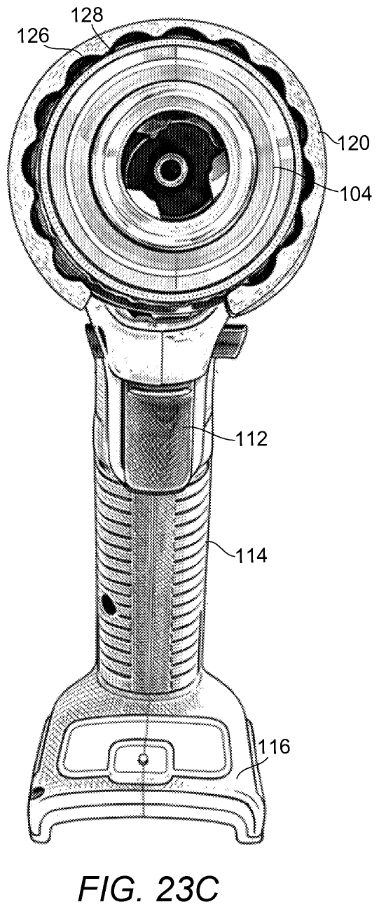

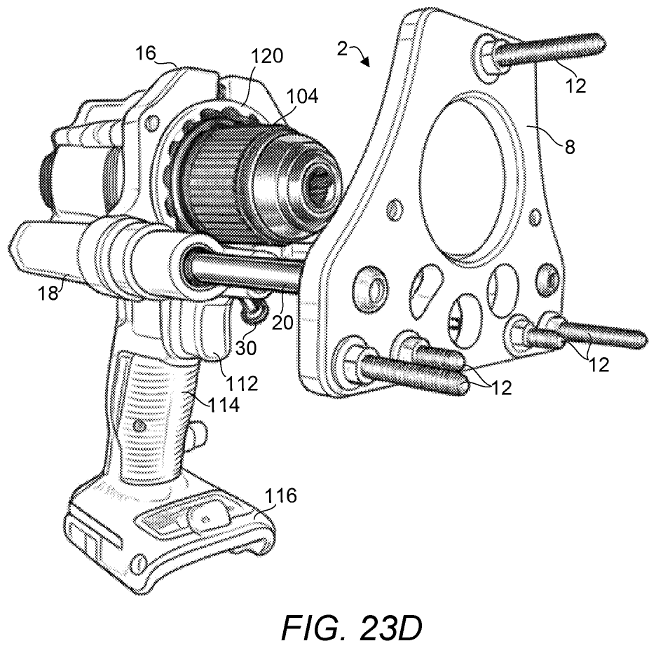

Referring further to FIGS. 19A-23D, the first adapter 120 is illustrated in connection with three different drill models. In FIGS. 19A-19D, the first adapter 120 is shown mounted to a first drill model, e.g., Milwaukee® M12 Fuel. In FIGS. 22A-22D, the same first adapter 120 is shown mounted to a second drill model, e.g., Dewalt® DCD800. In FIGS. 23A-23D, the same first adapter 120 is shown mounted to a third drill model, e.g., Dewalt® DCD794. Although the clutch adjustment rings 106 of the first, second, and third drill models may differ in diameter, rib geometry, surface contour, or axial positioning, one or more features of the curved band 122, e.g., grooves 126, lands 128, lips 130, 132, and step-down portion 124 of the first adapter 120 are configured such that the first adapter 120 can be used with each of these drill models. The ability of the first adapter 120 to conform to multiple drill geometries illustrates the versatility of this configuration and demonstrates that a single adapter design may provide securement and compatibility across more than one drill model. The chuck 104 is disposed adjacent the clutch adjustment ring 106 on the drill 4, such that the generally cylindrical portion engaged by the adapter 120 is positioned rearward of the chuck 104. The drill 4 further includes a transmission housing 108, a motor housing 110, a trigger switch 112, a handle 114, a battery receptacle 116, and a battery 118, each forming part of the overall drill assembly but not requiring modification for installation of the adapter 120. In some views, one or more of the transmission housing 108, motor housing 110, trigger switch 112, handle 114, battery receptacle 116, battery 118, and/or the drill bit 6 are not shown for purposes of clarity.

In certain embodiments, the plurality of grooves 126 and the relative dimensions of the curved band 122 provide sufficient radial compliance and surface engagement to accommodate variations in rib spacing and outer diameter among different drill models. In one embodiment, each of the plurality of grooves includes a cross-sectional profile including a curved portion defining a radius of curvature of about 1 inch to about 2 inches. In one embodiment, the plurality of grooves includes about 2 to about 25 grooves, wherein a suitable number of grooves is selected to accommodate ribs across a plurality of drill models and to provide sufficient flexure of the adapter to facilitate engagement and retention. Additionally, the step-down portion 124 provides a consistent outer mounting interface for the adjustable ring 16 of the tree-tapping tool 2 regardless of the underlying drill geometry. The step-down portion 124 further defines a shoulder or transition region between adjacent outer diameters of the curved band 122, the shoulder forming a stop 123 configured to engage a corresponding surface of the adjustable ring 16 as the adjustable ring 16 is installed over the step-down portion 124. In this manner, axial movement of the adjustable ring 16 relative to the adapter 120 is limited, thereby establishing a repeatable installed position of the adjustable ring 16 with respect to the adapter 120. As such, the first adapter 120 may be employed across multiple drills without modification of the adjustable ring 16 or other components of the tree-tapping tool 2 while maintaining consistent axial positioning of the tree-tapping tool 2. In certain embodiments, the adapter 120 defines a central axis 144 that is generally coaxial with a central axis 150 of the drill 4 when the adapter 120 is installed on the drill 4.

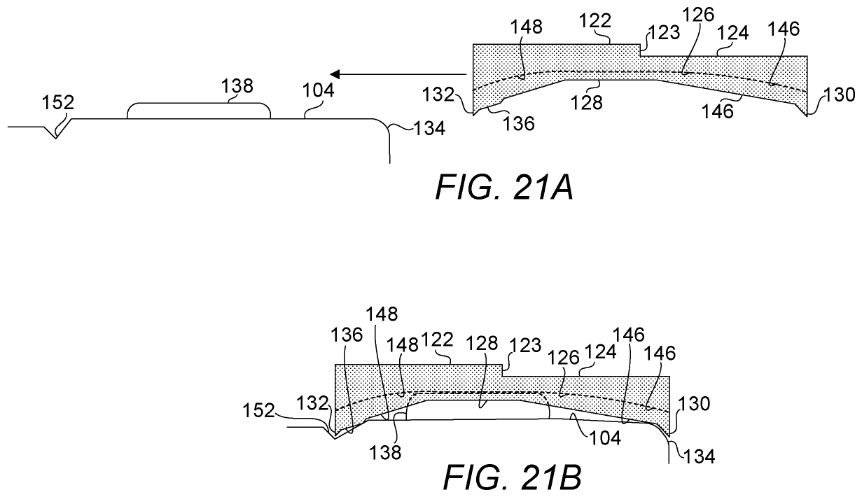

Referring now to FIGS. 21A and 21B, partial side cross-sectional views of the first adapter 120 are illustrated to depict the structural relationship between the curved band 122 and the clutch adjustment ring 106 of the drill 4. In FIG. 21A, the adapter 120 is shown axially aligned with the clutch adjustment ring 106 prior to full installation. The curved band 122 includes a plurality of grooves 126 separated by lands 128. A front lip 130 and a rear lip 132 extend radially inwardly from opposite circumferential sides of the curved band 122. The step-down portion 124 is disposed on the outer surface of the curved band 122 and, together with stop 123, defines a transition region for receiving the adjustable ring 16 (not shown in FIGS. 21A and 21B). In certain views, one or more structural features may not be drawn to scale in order to more clearly illustrate particular elements or relationships among components.

As shown in FIG. 21B, upon axial advancement of the adapter 120 over the clutch adjustment ring 106, one or more ribs 138 disposed on the clutch adjustment ring 106 are received within corresponding grooves 126. Engagement between the ribs 138 and grooves 126 resists relative rotational movement between the adapter 120 and the drill 4. In certain embodiments, the plurality of grooves 126 further reduces circumferential stiffness of the curved band 122 and permits controlled radial flexure of the adapter 120, thereby facilitating installation of the adapter 120 over the clutch adjustment ring 106 and improving conforming engagement therewith. The clutch adjustment ring 106 further includes an annular groove 152 and a rounded annular shoulder 134 formed along an outer surface of the clutch adjustment ring 106. The front lip 130 and rear lip 132 of the curved band 122 are configured to engage the outer surface of the clutch adjustment ring 106, including portions adjacent the annular groove 152 and rounded annular shoulder 134, to resist axial displacement of the adapter 120 relative to the drill 4. In certain embodiments, engagement surfaces 146 and 148 formed on the adapter 120 cooperate with corresponding outer surface portions of the clutch adjustment ring 106 to enhance axial retention.

In certain embodiments, a tab 136 is disposed at a rear circumferential side of a land 128 and projects radially inwardly toward the clutch adjustment ring 106. The tab 136 may engage an outer surface region of the clutch adjustment ring 106 to further resist axial movement of the adapter 120 once installed. The combined interaction among the grooves 126, lands 128, ribs 138, lips 130, 132, tab 136, and the structural features of the clutch adjustment ring 106 enhances both rotational stability and axial retention of the adapter 120 while permitting installation without modification of the drill 4. In certain embodiments, a tab (not shown) is disposed at a front circumferential side of a groove 126 or a land 128 and projects radially inwardly toward the clutch adjustment ring 106 to resist axial movement of the adapter 120.

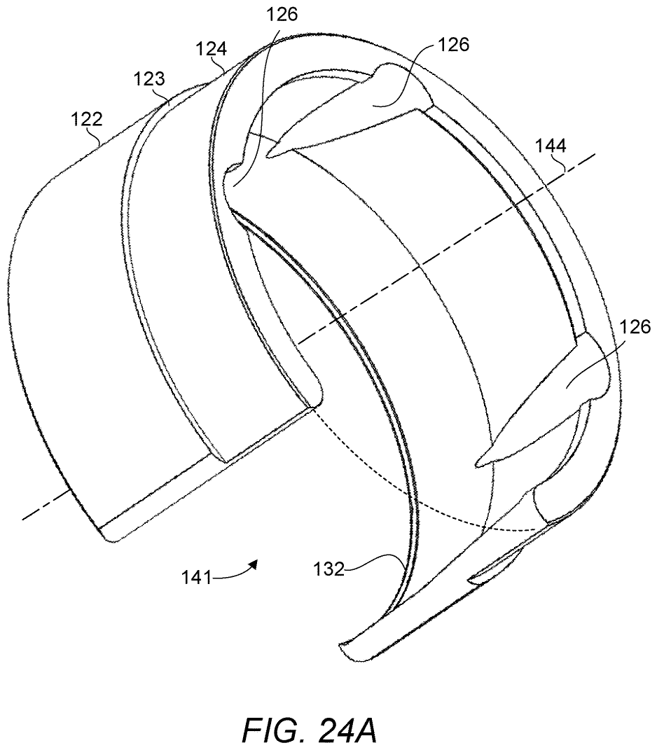

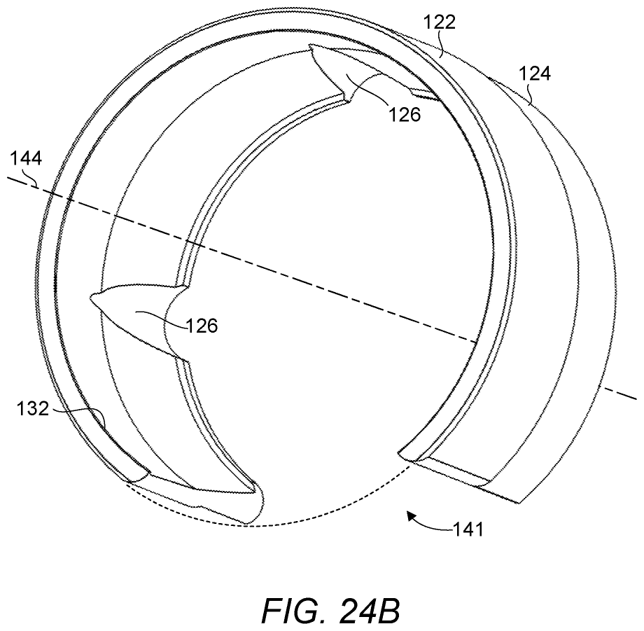

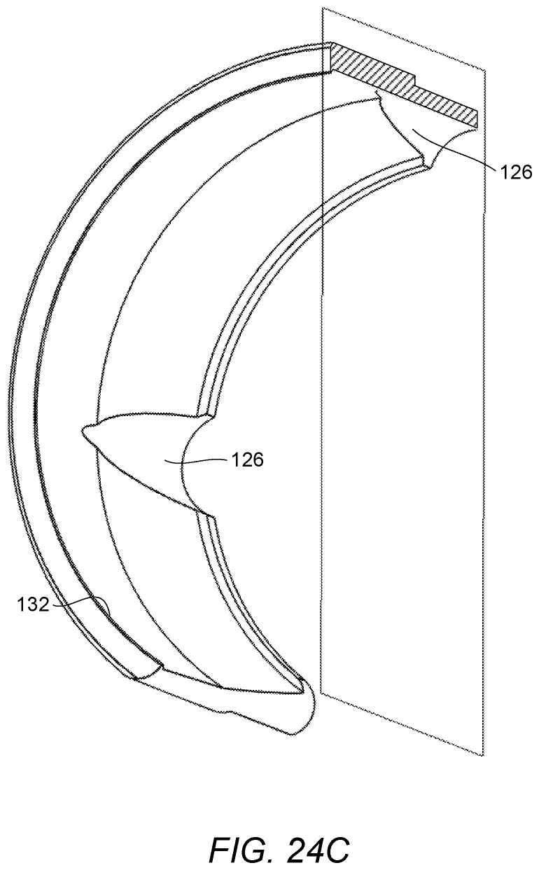

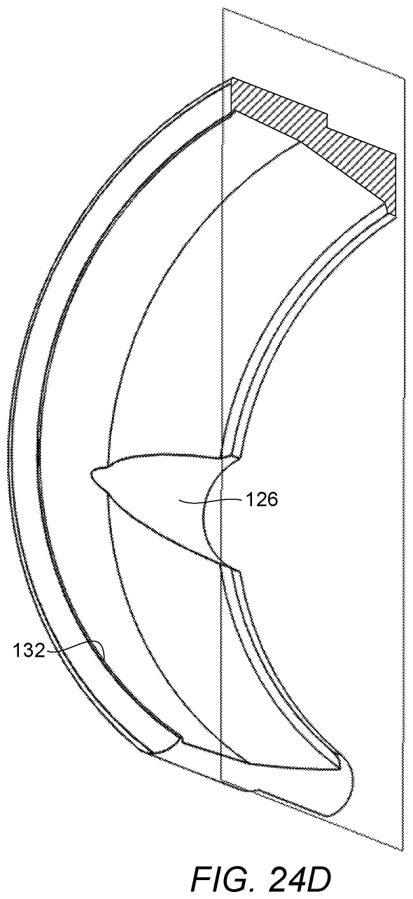

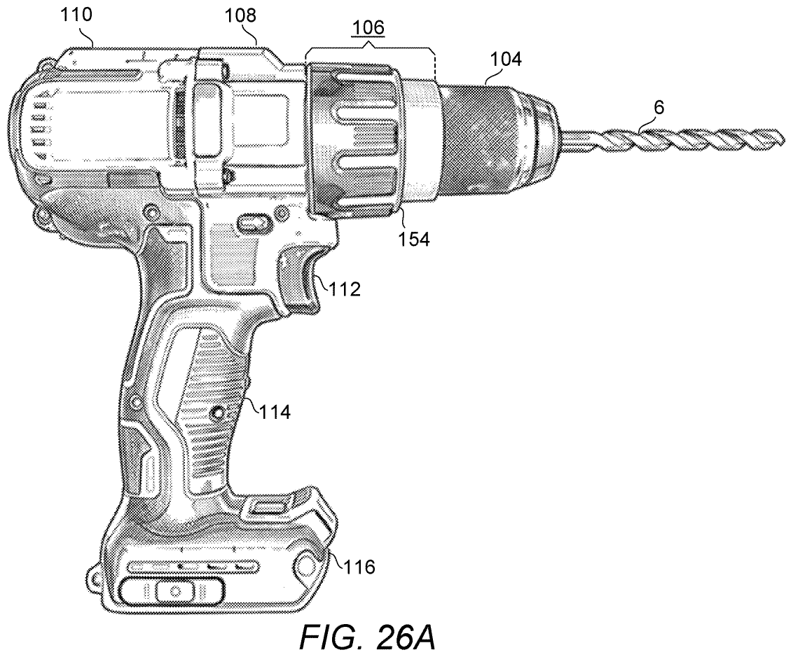

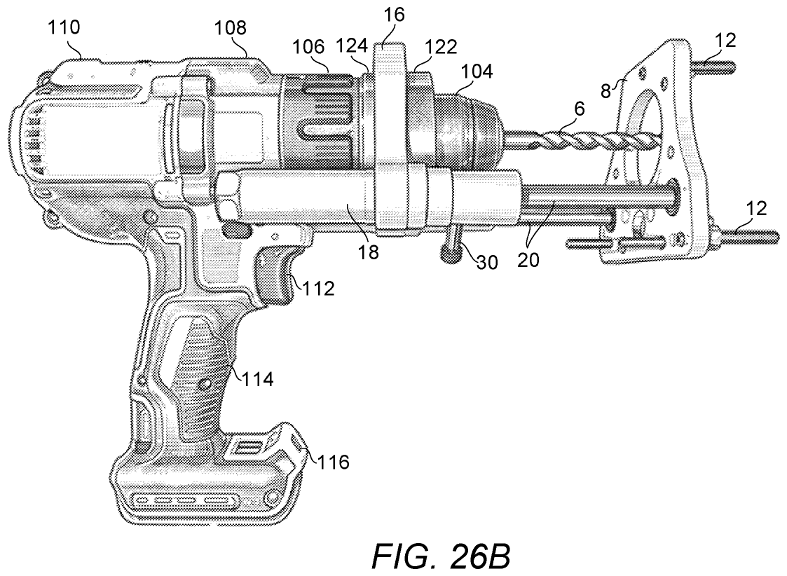

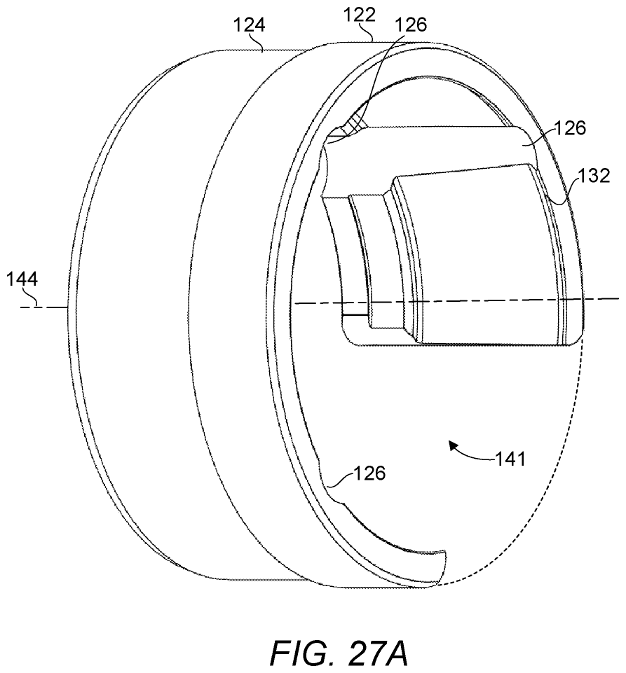

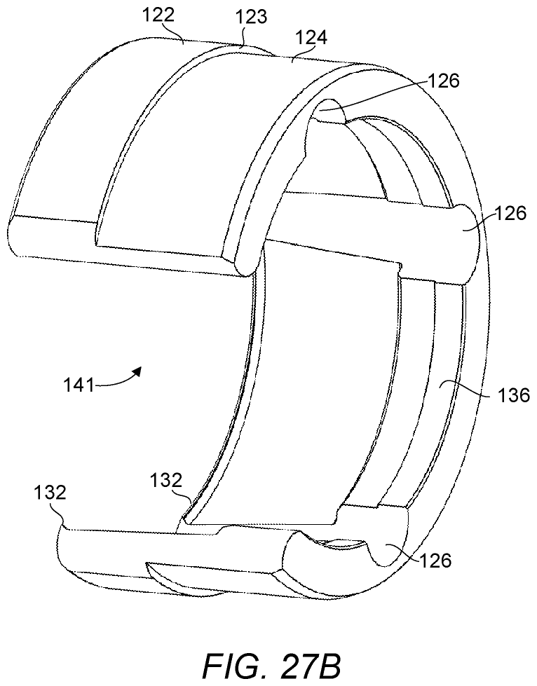

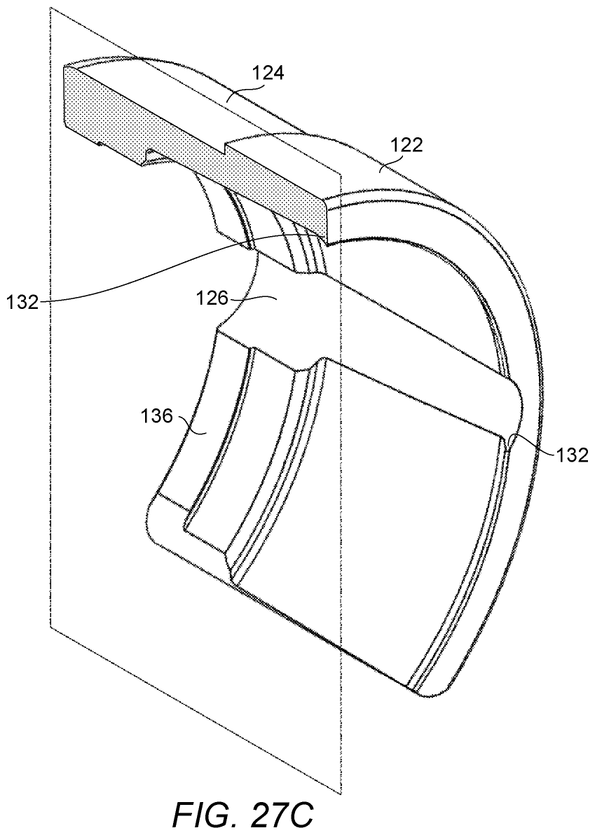

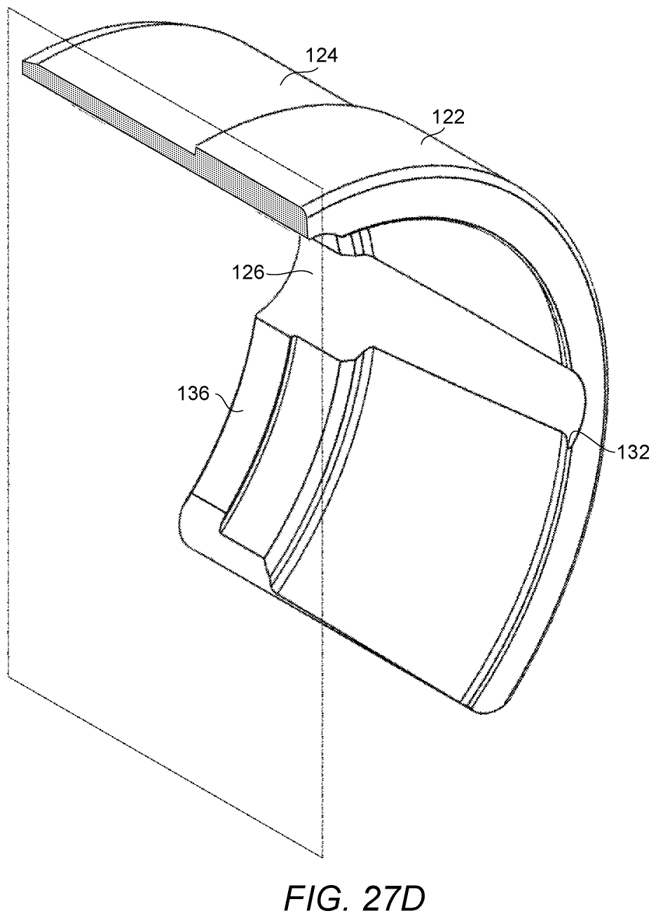

It is to be understood that drill geometries may vary significantly among manufacturers and models. In certain instances, dimensional differences, axial positioning of clutch features, or orientation of adjacent housings may make it desirable to provide an adapter having modified dimensions or structural features. Accordingly, FIGS. 24A-24D illustrate a second adapter embodiment 120 configured for compatibility with a fourth drill model, e.g., Milwaukee® Fuel, and FIGS. 26A-27D illustrate a third adapter embodiment 120 configured for compatibility with a fifth drill model, e.g., Dewalt® DCD996. While each adapter embodiment includes a curved band 122 defining an opening 141 and a step-down portion 124 disposed on an outer surface thereof, the relative dimensions, groove configuration, and axial positioning of structural features may differ to correspond to the geometry of the particular drill model for which the adapter is intended. In one embodiment, the ratio of the circumference of the band 140 to the circumference 142 of the opening 141 is about 190 degrees/170 degrees or 1.1 to about 310 degrees/50 degrees or 6.2 to ensure that the opening 141 can accommodate parts, e.g., the clutch adjustment ring 106 and trigger switch 112, etc., while maintaining sufficient surface contact between the adapter 120 and the clutch adjustment ring 106.

Referring specifically to FIGS. 26A and 26B, the third adapter embodiment 120 configured for the fifth drill model includes a step-down portion 124 that is disposed on an opposite axial side of the curved band 122 relative to the step-down portions of the first and second adapter embodiments. In the first and second adapter embodiments, the step-down portion 124 is disposed adjacent one circumferential side of the curved band 122 to correspond with the axial location of the adjustable ring 16 relative to the clutch adjustment ring 106 of those drill models, and the transition formed by the step-down portion 124 defines a shoulder that functions as a stop 123 for limiting axial advancement of the adjustable ring 16 during installation. In contrast, for the fifth drill model, the axial relationship between the clutch adjustment ring 106 and surrounding housing components differs, and therefore the step-down portion 124 of the third adapter embodiment is positioned on the opposite side of the curved band 122 to properly align the tree-tapping tool 2 with the fifth drill model. It shall be noted then that in this third embodiment, a stop 123 is likewise provided adjacent the step-down portion 124 and is configured to engage a corresponding surface of the adjustable ring 16 to establish a repeatable installed position of the adjustable ring 16 relative to the adapter 120. This configuration illustrates that while the structural principles of the adapter 120 remain consistent, the axial placement of the step-down portion 124 and associated stop 123 may be reversed to accommodate differences in drill geometry.

Accordingly, the embodiments shown in FIGS. 19A-27D demonstrate both that a single adapter configuration may be suitable for use with multiple drill models and that alternative adapter configurations may be provided when drill geometries differ to a greater extent. In each case, the adapter 120 provides an intermediary structure between the drill 4 and the adjustable ring 16, thereby enhancing securement, improving conformity, and providing a predictable mounting interface for the tree-tapping tool 2.

In certain embodiments, the curved band 122 may include fewer grooves 126, a single groove 126, or no grooves 126, wherein the curved band 122 is formed with a reduced thickness or otherwise configured to permit sufficient radial flexure to conform to the generally cylindrical portion of the drill 4, such that conforming engagement and retention may be achieved without reliance on multiple grooves 126.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. An adapter comprising:
(a) a curved band defining an opening and having an inner surface, an outer surface, a front circumferential side, and a rear circumferential side, the inner surface being disposed opposite the outer surface;
(b) a step-down portion disposed on and extending circumferentially about a radially outer surface of the curved band, the step-down portion having an outer diameter smaller than an outer diameter of an adjacent portion of the curved band; and
(c) a plurality of grooves disposed on the inner surface of the curved band, each groove extending in a direction from the front circumferential side to the rear circumferential side,
wherein the curved band is configured to be fitted over a generally cylindrical portion of a first object to secure the adapter to the first object, and
wherein the step-down portion is configured to receive a second object fitted over the step-down portion to secure the second object to the first object.

2. The adapter of claim 1, wherein the generally cylindrical portion of the first object comprises at least one radially protruding rib, and wherein at least one of the plurality of grooves is configured to receive the at least one rib to resist relative rotation between the adapter and the first object.

3. The adapter of claim 1, wherein the curved band further comprises at least one of:
(a) a first radially inwardly extending lip disposed at the front circumferential side; and
(b) a second radially inwardly extending lip disposed at the rear circumferential side, such that, upon fitting the curved band over the generally cylindrical portion of the first object, axial movement of the adapter relative to the first object is resisted by at least one of the first lip and the second lip.

4. The adapter of claim 1, wherein each of the plurality of grooves comprises a cross-sectional profile including a curved portion defining a radius of curvature of about 1 inch to about 2 inches.

5. The adapter of claim 1, wherein at least one of the plurality of grooves further comprises a tab disposed at the front circumferential side and projecting radially inwardly, the tab being configured to engage a surface of the first object to resist axial displacement of the adapter in a direction from the front circumferential side toward the rear circumferential side.

6. The adapter of claim 1, wherein at least one land disposed between two consecutive grooves further comprises a tab disposed at the rear circumferential side and projecting radially inwardly, the tab being configured to engage the first object to resist axial displacement of the adapter in a direction from the rear circumferential side toward the front circumferential side.

7. The adapter of claim 1, wherein the plurality of grooves comprises about 2 to about 25 grooves.

8. The adapter of claim 1, wherein a ratio of a circumference of the opening to a circumference of the curved band is about 190 degrees/170 degrees or 1.1 to about 310 degrees/50 degrees or 6.2.

9. The adapter of claim 1, wherein the first object comprises a rotatable clutch adjustment ring of a handheld drill.

10. A tree-tapping tool assembly configured to be mounted to a handheld drill having a drill bit with a central axis, the tree-tapping tool assembly comprising:
(a) an adapter configured to be mounted on a generally cylindrical portion of the handheld drill;
(b) an adjustable ring secured to the adapter;
(c) a front plate disposed distally from the adjustable ring and defining an aperture through which the drill bit extends;
(d) a plurality of surface-engaging members disposed on the front plate and configured to contact a tree surface; and
(e) a spacing structure extending between the adjustable ring and the front plate and configured to maintain a selectable distance between the front plate and the adjustable ring,
wherein the adapter is interposed between the handheld drill and the adjustable ring such that the adjustable ring is secured to the handheld drill by way of the adapter.

11. The tree-tapping tool assembly of claim 10, wherein the adapter comprises a curved band defining an opening and having an inner surface and an outer surface.

12. The tree-tapping tool assembly of claim 11, wherein the adapter further comprises a step-down portion disposed on and extending circumferentially about the outer surface of the curved band, the adjustable ring being secured over the step-down portion.

13. The tree-tapping tool assembly of claim 11, wherein the adapter further comprises a plurality of grooves disposed on the inner surface of the curved band.

14. The tree-tapping tool assembly of claim 13, wherein the plurality of grooves extend axially between opposite circumferential sides of the curved band and are configured to permit radial flexure of the curved band to facilitate conforming engagement with the generally cylindrical portion of the handheld drill.

15. The tree-tapping tool assembly of claim 13, wherein at least one of the plurality of grooves is configured to receive a rib disposed on the generally cylindrical portion of the handheld drill to resist relative rotation between the adapter and the handheld drill.

16. The tree-tapping tool assembly of claim 11, wherein the adapter further comprises at least one of:
(a) a first radially inwardly extending lip disposed at a front circumferential side of the curved band; and
(b) a second radially inwardly extending lip disposed at a rear circumferential side of the curved band,
such that axial movement of the adapter relative to the handheld drill is resisted by one of the first lip and the second lip.

17. The tree-tapping tool assembly of claim 10, wherein the spacing structure comprises at least one slide extending between the adjustable ring and the front plate and configured to permit relative axial movement therebetween.

18. The tree-tapping tool assembly of claim 17, wherein the at least one slide comprises a spring-loaded slide configured to bias the front plate away from the adjustable ring.

19. The tree-tapping tool assembly of claim 10, wherein the generally cylindrical portion of the handheld drill is a rotatable clutch adjustment ring configured to vary a torque threshold of the handheld drill.
